(19) United States
(12) Patent Application Publication
(10) Pub. No.: US 2013/0076861 A1
(43) Pub. Date: Mar. 28, 2013

(54) METHOD AND APPARATUS FOR PROBING AN OBJECT, MEDIUM OR OPTICAL PATH USING NOISY LIGHT

(71) Applicant: Shmuel Sternklar, Rehovot (IL)

(72) Inventor: Shmuel Sternklar, Rehovot (IL)

(21) Appl. No.: 13/555,505

(22) Filed: Jul. 23, 2012

Related U.S. Application Data
(63) Continuation-in-part of application No. 13/010,810, filed on Jan. 21, 2011.
Application No. 13/010,810 is a continuation-in-part of application No. PCT/IL2011/000075, filed on Jan. 23, 2011.

(30) Foreign Application Priority Data
Jan. 21, 2010 (IL) 203449

(51) Int. Cl. G01J 1/42; H04N 13/02; G01L 1/24

(52) U.S. Cl. CPC G01J 1/42; G01L 1/24; H04N 13/0253
USPC 348/46; 250/550; 73/800

(57) ABSTRACT

A method and apparatus for optically probing an object(s) and/or a medium and/or an optical path using noisy light. Applications disclosed include but are not limited to 3D digital camera, detecting material or mechanical properties of optical fiber(s), intrusion detection, and determining an impulse response. In some embodiments, an optical detector is illuminated by a superimposition of a combination of noisy light signals. Various signal processing techniques are also disclosed herein.

### CROSS REFERENCE TO RELATED APPLICATIONS

The present application draws priority from Israel Patent Application IL 203449 filed on Jan. 21, 2010 and is a continuation-in-part of U.S. application Ser. No. 13/010,810 filed on Jan. 21, 2011. The present application is a continuation-in-part of PCT/IL2011/000075 filed on Jan. 23, 2011—PCT/IL2011/000075 is incorporated herein by reference in its entirety.

### FIELD OF THE INVENTION

The present disclosure relates to techniques and apparatus for probing an object(s), medium(s) or optical path using noisy light.

### BACKGROUND AND RELATED ART

The following patents, patent applications and non-patent publications may be of interest. The disclosures of all patents and patent applications on the list below, and mentioned anywhere in the present disclosure, are hereby incorporated by reference:

[1] U.S. Pat. No. 6,392,585, Huff et al, “Random noise radar target detection device”, May 21, 2002.

[2] U.S. Pat. No. 6,864,834, Walton, “Radar system using random RF noise”, Mar. 8, 2005.

[3] T. Thayaparan and C. Wernik, “Noise radar technology basics”, Technical memorandum of Defense Research and Development, DRDC Ottawa TM 2006-266, December 2006

[4] Jiang et al, “Low coherence fiber optics for random noise radar”, in the MILCOM 2000—21st Century Military Communications Conference Proceedings, pp. 907-911 (2000)

[5] U.S. Pat. No. 5,034,678, Eichen et al, “Method of and apparatus for measuring the frequency response of an electrooptic device using an optical white noise generator”, Jul. 23, 1991.

[6] WO 2009/098694, Granot and Sternklar, “Methods and devices for analyzing material properties and detecting objects in scattering media”, Aug. 13, 2008.

[7] U.S. Pat. No. 7,505,135, Granot and Sternklar, “Method and apparatus for imaging through scattering or obstructing media”, Mar. 17, 2009.

### SUMMARY OF EMBODIMENTS

It is now disclosed a method of optically probing an object(s) and/or a medium and/or an optical path including the object(s) or medium, the method comprising: a) illuminating the object(s) or the medium to induce, from the object(s) or medium, one or more noisy light response signals that are randomly or pseudo-randomly modulated; b) receiving into an optical detector an optical superimposition of (i) a noisy source light signal used in step (a) to carry out the illuminating and (ii) one or more of the induced noisy light response signals, thereby illuminating the optical detector so as to generate a combination electrical signal describing the optically superimposed plurality of received noisy light response signals; c) determining or characterizing or detecting from the combination electrical signal, at least one of: i) a relationship between power and frequency of the combination electrical signal or a derivative thereof over a discrete or continuous spectrum; ii) a temporal autocorrelation function of the combination electrical signal; iii) a distance parameter(s) involving one or more the objects; iv) a mechanical stress or strain; v) a change in a light propagation time of at least one optical path; vi) a difference in light propagation times of multiple optical paths or a temporal change thereof; vii) mechanical motion of an object; and viii) a material or mechanical property of an optical fiber, at least a portion of which is included in the optical path of step (a).

It is now disclosed a method of optically probing an object(s) and/or a medium and/or an optical path including the object(s) or medium, the method comprising: a) illuminating the object(s) or the medium to induce, from the object(s) or medium, a plurality of noisy light response signals that are randomly or pseudo-randomly modulated, each induced noisy light response signal of the optical superimposition being associated with a different respective target location of the object(s) or medium and with a different respective target-location-including optical path; b) receiving into an optical detector an optical superimposition of the plurality of the noisy light response signals so as to illuminate the optical detector and to generate a combination electrical signal describing the optically superimposed plurality of received noisy light response signals; c) determining or characterizing or detecting from the combination electrical signal, at least one of: i) a relationship between power and frequency of the combination electrical signal or a derivative thereof over a discrete or continuous spectrum; ii) a temporal autocorrelation function of the combination electrical signal; iii) a distance parameter(s) involving one or more the objects; iv) a mechanical stress or strain; v) a change in a light propagation time of at least one optical path; vi) a difference in light propagation times of multiple optical paths or a temporal change thereof; vii) mechanical motion of an object; and viii) a material or mechanical property of an optical fiber, at least a portion of which is included in the optical path of step (a).

In some embodiments, step (c) or a portion thereof is contingent upon the sub-signals of the combination electrical signal sharing substantially the same noise-driven temporal fluctuations.

In some embodiments, the relationship between power and frequency is determined or characterized or detected.

In some embodiments, the temporal autocorrelation function is determined or characterized or detected.

In some embodiments, the distance parameter(s) is determined or characterized or detected.

In some embodiments, the change in a light propagation time of the at least one optical path is determined or characterized or detected.

In some embodiments, the difference in light propagation times of multiple optical paths or a temporal change thereof is determined or characterized or detected.

In some embodiments, the mechanical motion of the object is determined or characterized or detected.

In some embodiments, the object is a person or animal or moving vehicle.

In some embodiments, the optical fiber material or mechanical property is determined or characterized or detected.

In some embodiments, the optical superimposition of the plurality of noisy light response signals includes: a) first noisy light signal associated with a first target location and a first of the target-location-including optical paths; and ii) a second of the noisy light response signals associated with a second target location and a second of the target-location-including optical paths, the second target location being separated from the first target location by at least 1 mm.

In some embodiments, the noisy light response signal(s) include ultraviolet or visible light.

In some embodiments, the noisy light response signal(s) include infra-red light.

In some embodiments, the noisy light response signal(s) include near infra-red (NIR) light.

In some embodiments, at least one target-location-including optical path is primarily within an optical fiber.

In some embodiments, at least one target-location-including optical path is primarily free space.

In some embodiments, a source of the illumination is aimed from a moving vehicle and/or at a moving vehicle.

In some embodiments, the method includes analyzing noise patterns of the combination electrical signal or of a derivative thereof.

In some embodiments, step (c) or a portion thereof is carried out in accordance with the results of the analysis of the noise patterns.

In some embodiments, the source signal used in step (a) to carry out the illuminating is a noisy source signal.

In some embodiments, the source signal used in step (a) to carry out the illuminating is not a noisy source signal.

In some embodiments, a bandwidth of the optical detector exceeds a noise bandwidth of one or more of noisy light signals of the optical superimposition received therein.

A “bandwidth” and “speed” of the optical detector reflects the characteristic time constants of optical detector electronics which converts the light signal received by the detector into an electrical signal descriptive of the light signal received by the detector

In some embodiments, a bandwidth of the optical detector exceeds a noise bandwidth of one or more of noisy light signals of the optical superimposition received therein by at least a factor of 10, or at least a factor of 100, or at least a factor of 1000.

In some embodiments, a bandwidth of the optical detector exceeds a noise bandwidth of one or more of noisy light signals of the optical superimposition received therein by at least a factor of 100.
In some embodiments, a bandwidth of the optical detector exceeds a noise bandwidth of one or more of noisy light signals of the optical superimposition received therein by at least a factor of 1,000.

In some embodiments, a noise bandwidth of one or more of noisy light signals of the optical superimposition exceeds a bandwidth of the optical detector.

In some embodiments, a noise bandwidth of one or more of noisy light signals of the optical superimposition exceeds a bandwidth of the optical detector by at least a factor of 10, or at least a factor of 100, or at least a factor of 1000.

In some embodiments, a noise bandwidth of one or more of noisy light signals of the optical superimposition and/or a bandwidth of the optical detector is less than 50 GHz or less than 10 GHz or less than 1 GHz or less than 100 MHz.

In some embodiments, the source signal used in step (a) to carry out the illuminating is a noisy source signal having a noise bandwidth selected in accordance with a desired depth resolution.

It is now disclosed apparatus for optically probing an object(s) and/or a medium and/or an optical path including the object(s) or medium, the apparatus comprising: a) a source of light configured to illuminate the object(s) or the medium to induce, from the object(s) or medium, one or more noisy light response signals that are randomly or pseudo-randomly modulated; b) an optical detector configured to receive an optical superimposition of (i) a noisy source light signal used in step (a) to carry out the illuminating and (ii) one or more of the induced noisy light response signals, thereby illuminating the optical detector so as to generate a combination electrical signal describing the optically superimposed plurality of received noisy light response signals; c) electronic circuitry configured to determine or characterize or detect from the combination electrical signal, at least one of: i) a relationship between power and frequency of the combination electrical signal or a derivative thereof over a discrete or continuous spectrum; ii) a temporal autocorrelation function of the combination electrical signal; iii) a distance parameter(s) involving one or more the objects; iv) a mechanical stress or strain; v) a change in a light propagation time of at least one optical path; vi) a difference in light propagation times of multiple optical paths or a temporal change thereof; vii) mechanical motion of an object; and viii) a material or mechanical property of an optical fiber, at least a portion of which is included in the optical path of step (a).

It is now disclosed apparatus for optically probing an object(s) and/or a medium and/or an optical path including the object(s) or medium, the apparatus comprising: a) a source of light configured illuminate the object(s) or the medium to induce, from the object(s) or medium, a plurality of noisy light response signals that are randomly or pseudo-randomly modulated, each induced noisy light response signal of the optical superimposition being associated with a different respective target location of the object(s) or medium and with a different respective target-location-including optical path; b) an optical detector configured to receive an optical superimposition of the plurality of the noisy light response signals so as to illuminate the optical detector and to generate a combination electrical signal describing the optically superimposed plurality of received noisy light response signals; c) electronic circuitry configured to determine or characterize or detect from the combination electrical signal, at least one of: i) a relationship between power and frequency of the combination electrical signal or a derivative thereof over a discrete or continuous spectrum; ii) a temporal autocorrelation function of the combination electrical signal; iii) a distance parameter(s) involving one or more the objects; iv) a mechanical stress or strain; v) a change in a light propagation time of at least one optical path; vi) a difference in light propagation times of multiple optical paths or a temporal change thereof; vii) mechanical motion of an object; and viii) a material or mechanical property of an optical fiber, at least a portion of which is included in the optical path of step (a).

In some embodiments, the source of light is a source of noisy light.

In some embodiments, the light produced by the light source is not noisy light.

In some embodiments, the electronic circuitry includes any combination of analog electronics, digital electronics and computer code/software.

It is now disclosed a method of optically probing an object(s) and/or a medium and/or an optical path including the object(s) or medium, the method comprising: a) illuminating the object(s) or the medium to induce, from the object(s) or medium, one or more of noisy light response signals that are randomly or pseudo-randomly modulated; b) simultaneously receiving into an optical detector an optical superimposition of at least one of: i) a plurality of the noisy light response signals, each induced noisy light response signal associated with a respective target location of the object(s) or medium and with a different respective target-location-including optical path; ii) a noisy source light signal used in step (a) to carry out the illumination and to induce one or more of the noisy light response signals, so as to illuminate the optical detector and to generate a combination electrical signal describing the optically superimposed plurality of received noisy light response signals; and c) determining or characterizing or detecting from the combination electrical signal, at least one of: i) a relationship between power and frequency of the combination electrical signal or a derivative thereof over a discrete or continuous spectrum; ii) a temporal autocorrelation function of the combination electrical signal; iii) a distance parameter(s) involving one or more the objects; iv) a mechanical stress or strain; v) a change in a light propagation time of at least one optical path; vi) a difference in light propagation times of multiple optical paths or a temporal change thereof; vii) mechanical motion of an object; and viii) a material or mechanical property of an optical fiber, at least a portion of which is included in the optical path of step (a).

In some embodiments, step (c) or a portion thereof is contingent upon the sub-signals of the combination electrical signal sharing substantially the same noise-driven temporal fluctuations.

Examples of objects include persons or animals or moving vehicles.

In some embodiments, the optical superimposition of the plurality of noisy light response signals includes: a) first noisy light signal associated with a first target location and a first of the target-location-including optical paths; and ii) a second of the noisy light response signals associated with a second target location and a second of the target-location-including optical paths, the second target location being separated from the first target location by at least 1 mm (or at least 0.5 mm or at least 2 mm or at least 5 mm).

In some embodiments, a source of the illumination is aimed from a moving vehicle and/or at a moving vehicle.

It is now disclosed apparatus for optically probing an object(s) and/or a medium and/or an optical path including the object(s) or medium, the apparatus comprising: a) a source of noisy light configured to illuminate the object(s) or the medium to induce, from the object(s) or medium, one or more of noisy light response signals that are randomly or pseudo-randomly modulated; b) an optical detector configured be illuminated by an optical superimposition of at least one of: i) a plurality of the noisy light response signals, each induced noisy light response signal associated with a respective target location of the object(s) or medium and with a different respective target-location-including optical path; and ii) a noisy source light signal of the light source that is to carry out the illumination and to induce the one or more of the noisy light response signals, so as to generate a combination electrical signal describing the optically superimposed plurality of received noisy light response signals; and c) electronic circuitry configured to determine or characterize or detect from the combination electrical signal, at least one of: i) a relationship between power and frequency of the combination electrical signal or a derivative thereof over a discrete or continuous spectrum; ii) a temporal autocorrelation function of the combination electrical signal; iii) a distance parameter(s) involving one or more the objects; iv) a mechanical stress or strain; v) a change in a light propagation time of at least one optical path; vi) a difference in light propagation times of multiple optical paths or a temporal change thereof; vii) mechanical motion of an object; viii) a material or mechanical property of an optical fiber, at least a portion of which is included in the optical path of step (a).

In some embodiments, the electronic circuitry includes any combination of analog electronics, digital electronics and computer code/software.

A 3D digital camera device for acquiring a digital image of a scene comprises: a) a noisy light source configured to generate noisy light that is randomly or pseudo-randomly modulated, thereby illuminating a plurality of different scene locations within the scene to induce noisy light response signals from the different scene locations within the scene; b) an image sensor including a substantially-planar two-dimensional array of photodetector; c) optical components configured to focus or re-direct noisy light received from the scene onto or to the image sensors, the optical component(s) and the image sensor being configured so that each photodetector of the two-dimensional array: i) is respectively illuminated by a different respective optical superimposition noisy light signal that is an optical imposition of: A) a different respective noisy light response signal from a different respective scene location; and B) a respective reference optical signal whose temporal noise fluctuations are correlated to and temporally offset from the respective noisy light response signal; and ii) generates a different respective temporally-fluctuating electrical signal that respectively describes the respective optical imposition noisy light signal; d) electrical circuitry configured to compute from temporal power spectral density data or temporal autocorrelation data of the temporally-fluctuating electrical signals generated by the photodetectors, a three-dimensional digital image including a plurality of pixels corresponding to the locations in the scene, each visually pixel representing depth data and grayscale or color data at respective location.

A 3D digital camera device for acquiring a digital image of a scene comprising: a) a noisy light source configured to generate noisy light that is randomly or pseudo-randomly modulated, thereby illuminating a plurality of different scene locations within the scene to induce noisy light response signals from the different scene locations within the scene; b) an image sensor including a substantially-planar two-dimensional array of photodetector; c) optical components configured to focus or re-direct noisy light received from the scene onto or to the image sensors, the optical component(s) and the image sensor being configured so that each photodetector of the two-dimensional array: i) receives a different respective noisy response signal from a different respective scene location; ii) generates a different respective temporally-fluctuating electrical signal that respectively the respective noisy response signal from the respective scene location; d) electrical circuitry configured to compute from temporal power spectral density data or temporal autocorrelation data of the temporally-fluctuating electrical signals generated by the photodetectors, a three-dimensional digital image including a plurality of pixels corresponding to the locations in the scene, each visually pixel representing depth data and grayscale or color data at respective location.

In some embodiments, the electrical circuitry includes any combination of analog and/or digital electronics and/or software.

In some embodiments, the image sensor and the electrical circuitry are configured to generate 3D video content of the scene.

In some embodiments, the scene is a landscape scene or microscopic scene or a medical scene.

A method of employing a light source and a detector to optically probe an object(s), medium or an optical path with noisy light, the method comprises: a) sending light from the light source to the light detector so that the light travels along an optical path en route from the source to the detector so that at least one noisy light signal from the sent light illuminates the optical detector; and b) for two or more noisy different electrical signals or sub-signals that co-reside within a common combination electrical signal or that reside in separate electrical signals, the electrical signals sharing substantially the same noise-driven temporal fluctuations as the illuminating at least one noisy light signal such that two or more of the noisy electrical signals are temporally-offset from each other, determining or characterizing or detecting from the combination electrical signal, at least one of: i) a relationship between power and frequency of the combination electrical signal or a derivative thereof over a discrete or continuous spectrum; ii) a temporal autocorrelation function of the combination electrical signal; iii) a distance parameter(s) involving one or more the objects; iv) a mechanical stress or strain; v) a change in a light propagation time of at least one optical path; vi) a difference in light propagation times of multiple optical paths or a temporal change thereof; vii) mechanical motion of an object; and viii) a material or mechanical property of an optical fiber, at least a portion of which is included in the optical path of step (a).

Apparatus for optically probe an object(s), medium or an optical path with noisy light, the method comprising: a) a light source configured to send light from the light source to the light detector so that the light travels along an optical path en route from the source to the detector so that at least one noisy light signal from the sent light illuminates the optical detector; b) the optical detector configured to generate a detector electrical signal according to the noisy light signal illumination; c) electronic circuitry configured to process at least two or more noisy different electrical signals or sub-signals that co-reside within a common combination electrical signal or that reside in separate electrical signals, the processed signal(s) derived at least in part from the detector electrical signal, the processed electrical signals sharing substantially the same noise-driven temporal fluctuations as the illuminating at least one noisy light signal such that two or more of the noisy electrical signals are temporally-offset from each other, determining or characterizing or detecting from the combination electrical signal, at least one of: i) a relationship between power and frequency of the combination electrical signal or a derivative thereof over a discrete or continuous spectrum; ii) a temporal autocorrelation function of the combination electrical signal; iii) a distance parameter(s) involving one or more the objects; iv) a mechanical stress or strain; v) a change in a light propagation time of at least one optical path; vi) a difference in light propagation times of multiple optical paths or a temporal change thereof; vii) mechanical motion of an object; and viii) a material or mechanical property of an optical fiber, at least a portion of which is included in the optical path of step (a).

A method of employing a light source and a detector to optically probe an object(s), medium or an optical path with noisy light, the method comprising: a) sending light from the light source to the light detector so that the light travels along an optical path en route from the source to the detector so that at least one noisy light signal from the sent light illuminates the optical detector; and b) processing the electrical signal generated by the optical detector so as to determine or characterize or detect at least one of: i) a distance parameter(s) involving one or more the objects; ii) a mechanical stress or strain or indication thereof; iii) a change in a light propagation time of at least one optical path; iv) a difference in light propagation times of multiple optical paths or a temporal change thereof; vii) mechanical motion of an object; and viii) a material or mechanical property of an optical fiber, at least a portion of which is included in the optical path of step (a).

Apparatus for optically probing an object(s), medium or an optical path with noisy light, the apparatus comprises; a) an optical detector; b) a light source configured to sent light from the light source to the light detector so that the light travels along an optical path en route from the source to the detector so that at least one noisy light signal from the sent light illuminates the optical detector and to cause the optical detector to generate an electrical signal describing illuminating noisy light signal(s); c) electronic circuitry configured to process the electrical signal generated by the optical detector so as to determine or characterize or detect at least one of: i) a distance parameter(s) involving one or more the objects; ii) a mechanical stress or strain or indication thereof; iii) a change in a light propagation time of at least one optical path; iv) a difference in light propagation times of multiple optical paths or a temporal change thereof; vii) mechanical motion of an object; and viii) a material or mechanical property of an optical fiber, at least a portion of which is included in the optical path of step (a).

### BRIEF DESCRIPTION OF THE DRAWINGS

FIGS. 1, 8-9A, 10-11, 18-19 are flow charts of routines for probing an object(s), medium, or optical path using noisy light.

FIGS. 2-7, 9B, 12-17, 20-23 are diagrams of systems for probing an object(s), medium, or optical path using noisy light.

### DETAILED DESCRIPTION OF EMBODIMENTS

The claims below will be better understood by referring to the present detailed description of example embodiments with reference to the figures. The description, embodiments and figures are not to be taken as limiting the scope of the claims. It should be understood that not every feature of the presently disclosed portable media device and method of operating the same is necessary in every implementation. It should also be understood that throughout this disclosure, where a process or method is shown or described, the steps of the method may be performed in any order or simultaneously, unless it is clear from the context that one step depends on another being performed first. As used throughout this application, the word “may” is used in a permissive sense (i.e., meaning “having the potential to’), rather than the mandatory sense (i.e. meaning “must”).

### Introduction

Embodiments of the disclosed subject matter relate to optical-noise-radar-based apparatus and methods for optically probing an object and/or a medium using ‘noisy’ optical radiation. It is well-known in the art that optical radiation is subdivided into ultraviolet radiation (UV), the spectrum of light visible for man (VIS) and infrared radiation (IR). In the present disclosure, the terms ‘light’ and ‘optical radiation’ are used interchangeably—noisy light can refer to any combination of UV, VIS and/or IR light.

The term ‘noisy’ light refers to light that is randomly or pseudo-randomly modulated—the modulation may be any combination of: 1) amplitude modulation, 2) phase modulation, 3) frequency modulation, and/or 4) polarization modulation.

In some embodiments, the cross-correlation between a noisy return optical radiation signal of returning from a target and a noisy source light signal used to illuminate the target peaks at a time delay corresponding to the round-trip time to the target. Knowledge of this temporal cross-correlation is thus useful for computing distance-related parameters and other parameters described below.

Some embodiments of the disclosed subject-matter relate to the following features:

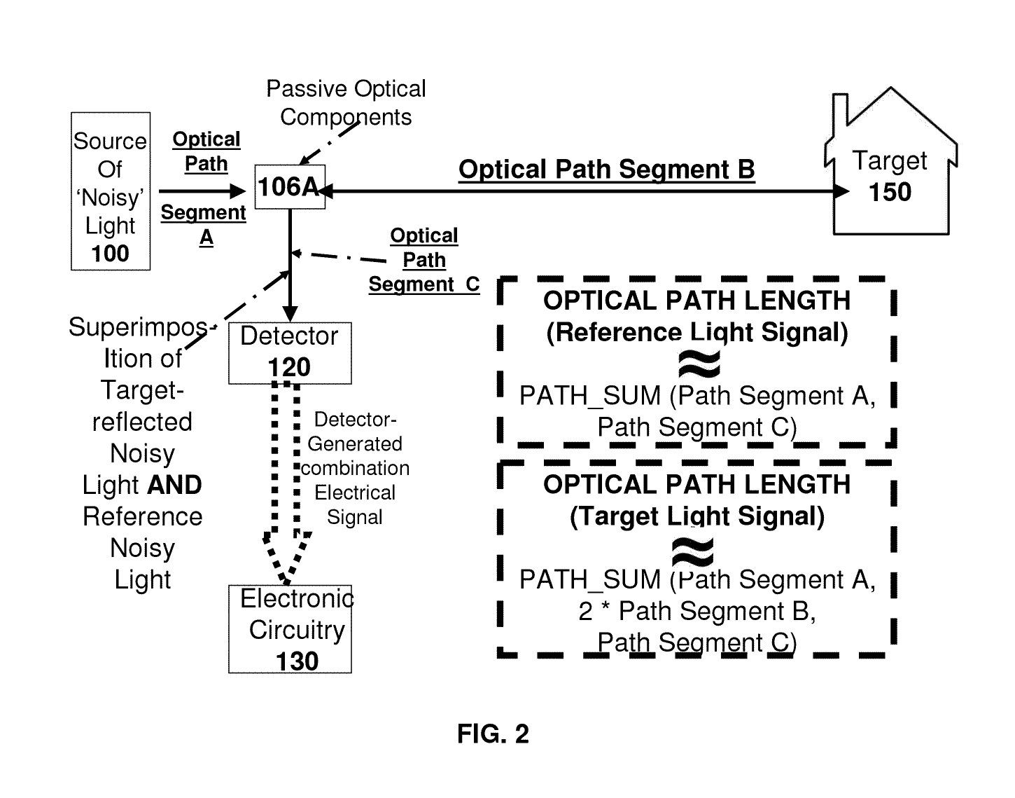

(i) An apparatus and method for probing an object, medium and/or light path(s) where a superimposition of two or more noisy light signals is received into the same optical detector (FEATURE A). This optical detector is thus simultaneously illuminated by the superimposed noisy light signals. Even though these noisy light signals are only detected when superimposed on each other, it is possible to compute physical parameters related to the fact that these two or more noisy light signals are distinct from each other. In some embodiments, an indication of a temporal relationship between these two or more noisy light signals that is contingent upon these signals having substantially identical noise content is used to derive one or more physical parameters of the object, medium or an optical path(s) involving the object. (see, for example, FIGS. 2-4, 12-15)—also see ‘A mathematical discussion of FEATURE A.’

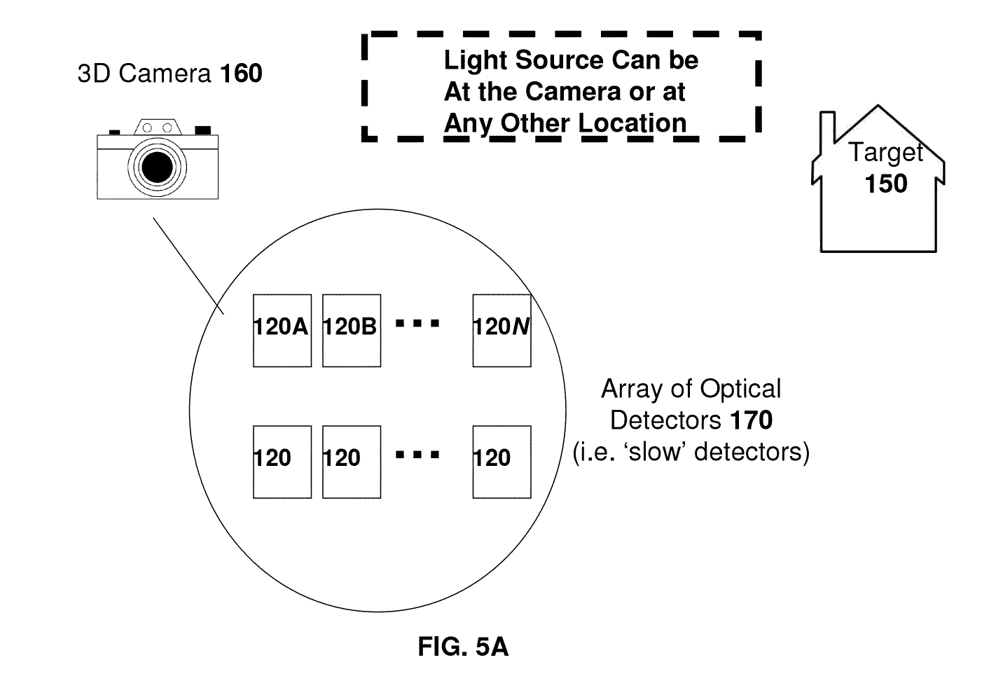

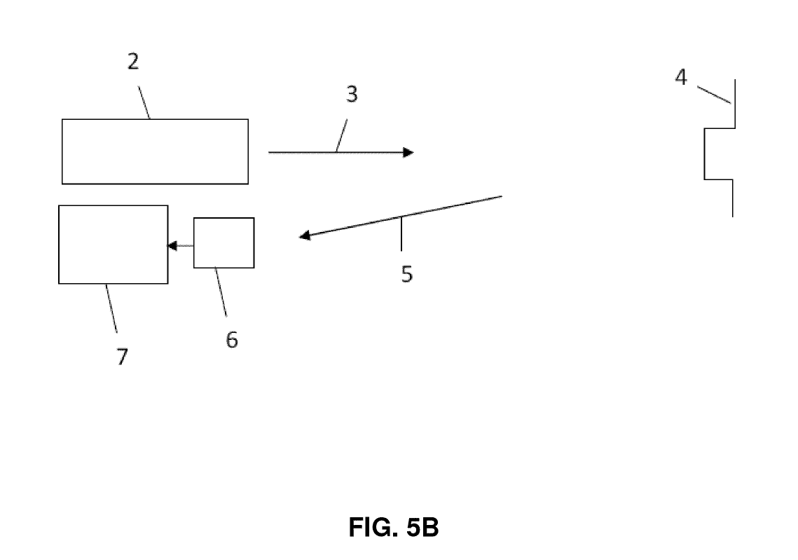

(ii) three-dimensional cameras based upon optical noise radar—for example, as ‘stand-alone’ products or as part of a computer gaming system or in any other context—see, for example, FIG. 5 (FEATURE B);

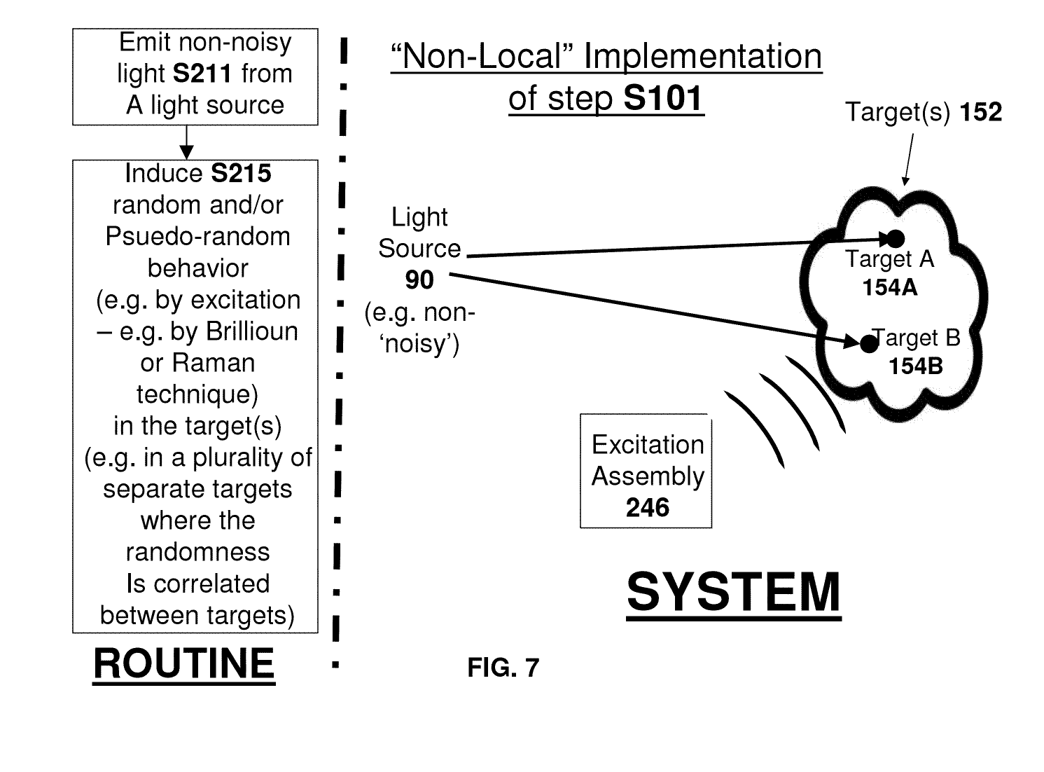

(iii) optical noise-radar based systems and methods whereby the target object or medium itself imbues light with ‘noise’ characteristics—see, for example, FIG. 7 (FEATURE C);

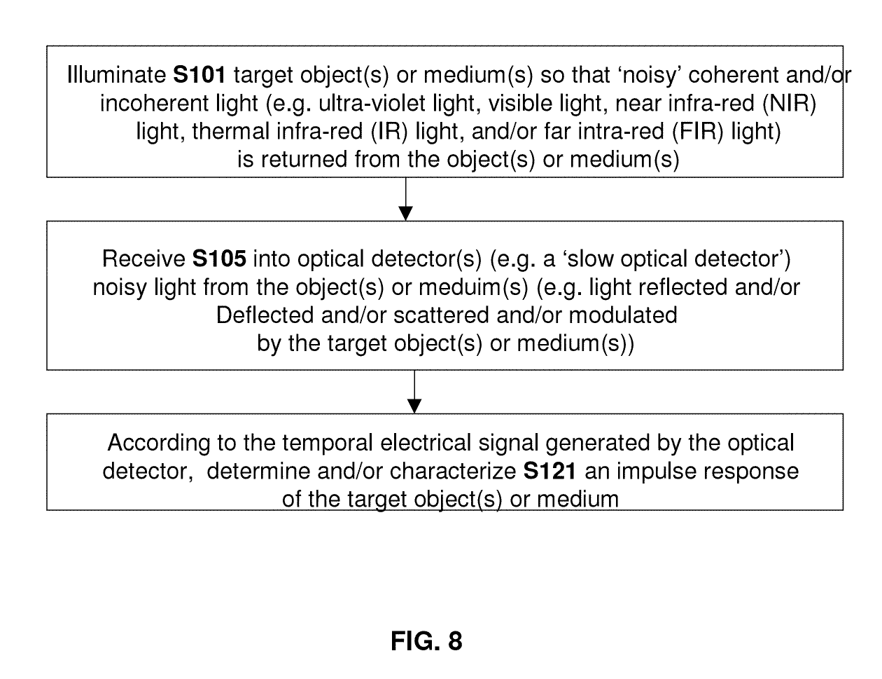

(iv) optical noise-radar based systems and methods for measuring an impulse response of a target option of medium—see, for example, FIG. 8 (FEATURE D);

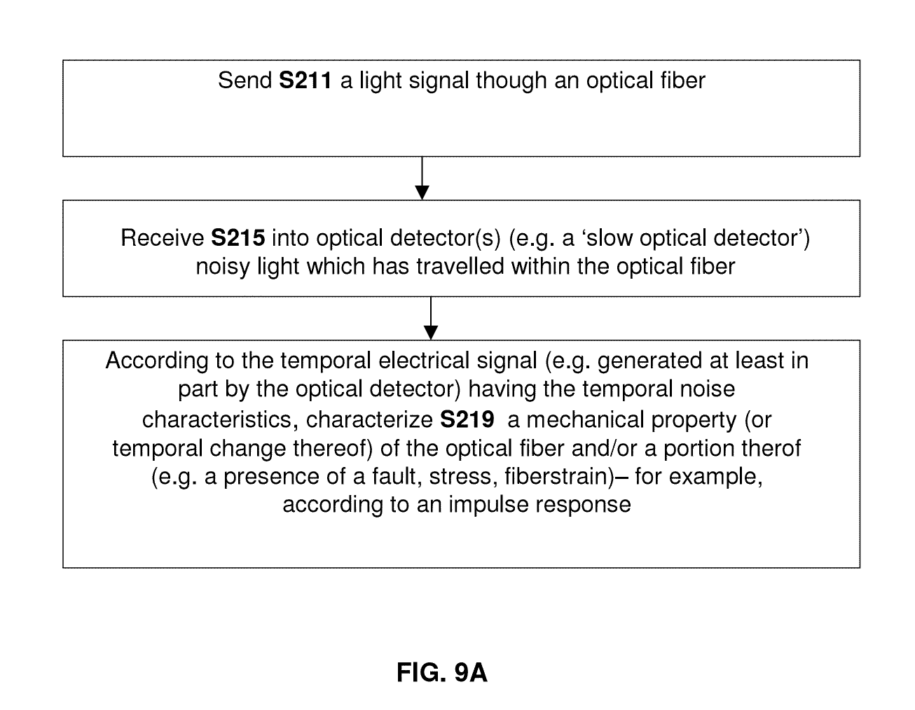

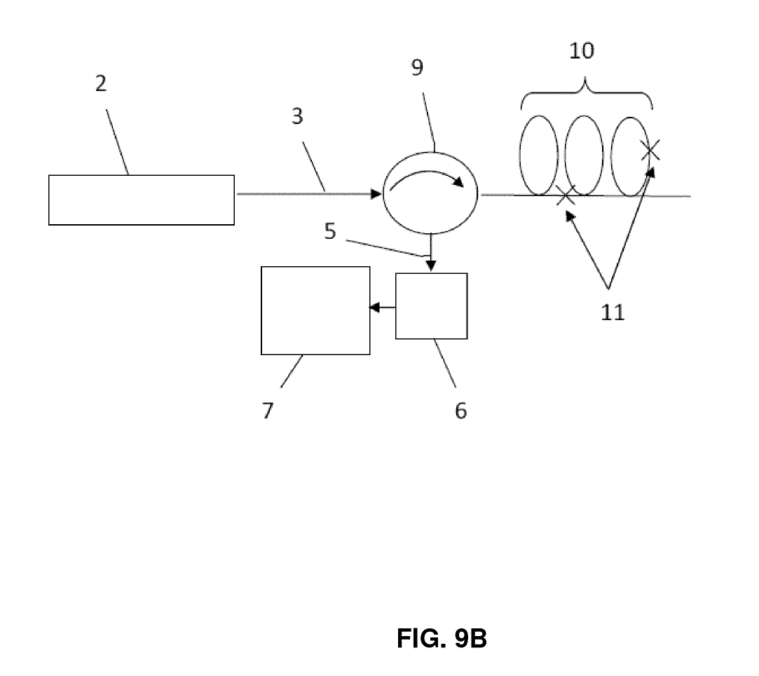

(v) optical noise-radar-based systems for measuring and/or monitoring a mechanical and/or material property of an optical fiber—see, for example, FIGS. 9 and 15-17 (FEATURE E);

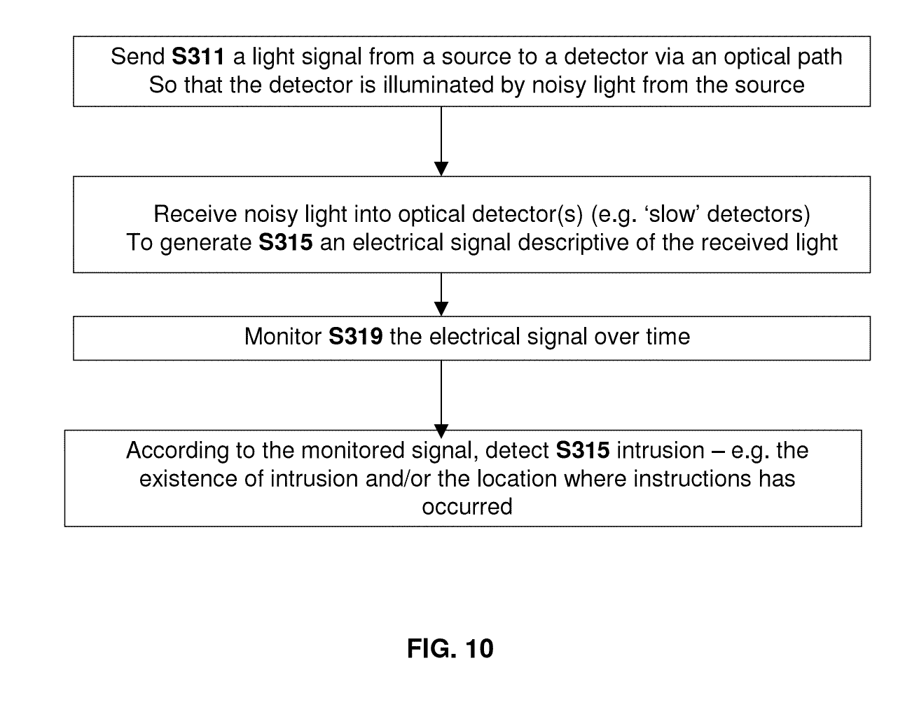

(vi) optical noise-radar-based intrusion detection systems and methods—see, for example, FIGS. 10-17 (FEATURE F);

(vii) optical noise-radar-based systems for measuring a temporal change in an optical path (FEATURE G)—an optical path is not necessarily the same as a physical path, and may change when a physical path length changes or when an optical property of a object or medium along the path changes—for example a refractive index or a reflectivity or any other optical property;

(viii) optical noise-radar-based systems where noisy light received from a target is processed according to a spectral technique where only specific discrete frequencies are monitored and/or optical power properties are detected only for specific discrete frequencies (FEATURE H)—this is in contrast to spectral techniques where a continuous spectrum is monitored.

Various embodiments may include any feature disclosed in the present document, including but not limited to the aforementioned features or any other feature(s), in any combination including combinations explicitly described in the present disclosure, and other combinations not explicitly mentioned herein (for example, for the sake of brevity).

In some embodiments, it is possible to measure and/or detect and/or monitor any of the following by according to temporal patterns in noisy light received from a target:

(i) a distance (or velocity) to an object(s) or between object(s);

(ii) an object shape, or dimensions of an object;

(iii) relative distances between (and hence, any geometric feature of) multiple targets—e.g. multiple objects or multiple locations on a single object and/or multiple locations within a medium;

(iv) an impulse response of light;

(v) a change in one or more optical paths traversed by noisy light;

(vi) a velocity and/or Doppler-related parameter.

In some embodiments, it is possible to process a noisy light signal received into an optical detector(s) using any combination of the following signal-processing techniques:

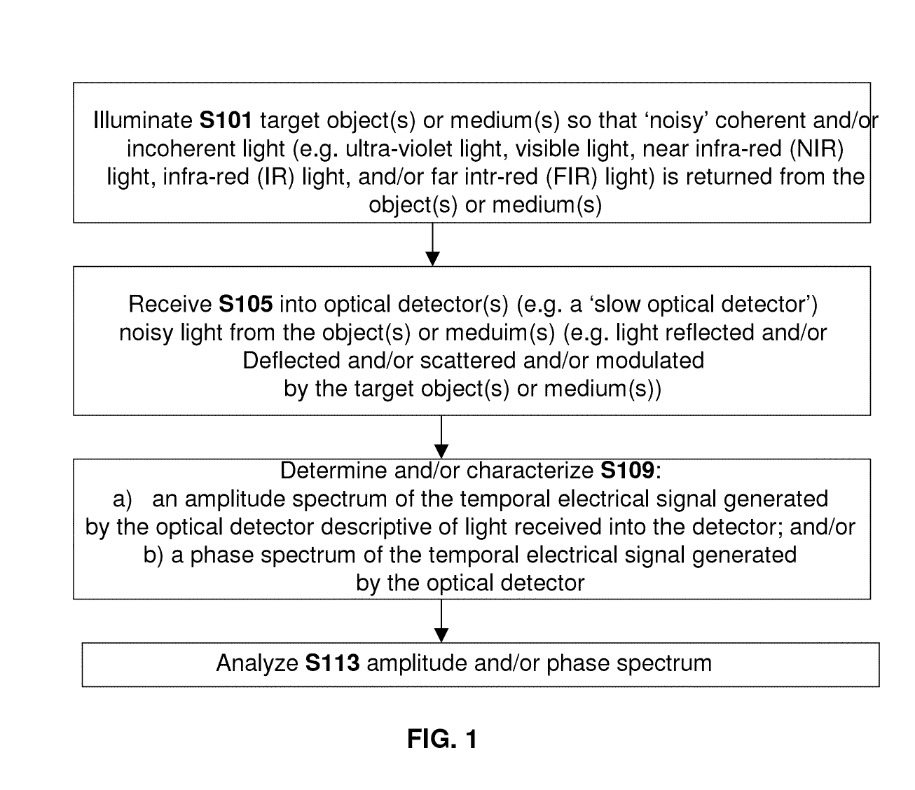

(i) spectral techniques see, for example, FIGS. 1, 18-19. One specific case of spectral techniques is the so-called double-spectral technique, where the first spectral signal processing operation may be implemented in step S109 of FIG. 1, and the second ‘spectral’ signal processing operation may be implemented in step S113 of FIG. 1 (discussed below). In some embodiments, spectral techniques relate to a continuous spectrum of frequencies; in other embodiments, spectral technique relate to only a plurality of discrete frequencies; and

(ii) temporal or correlation techniques—the noisy light is detected by an optical detector to generated an temporally-varying electrical descriptive thereof. This electrical signal is processed using an electrical delay line or using computer memory to explicitly determine a correlation according to some time delay between the detected noisy light with the original noisy light.

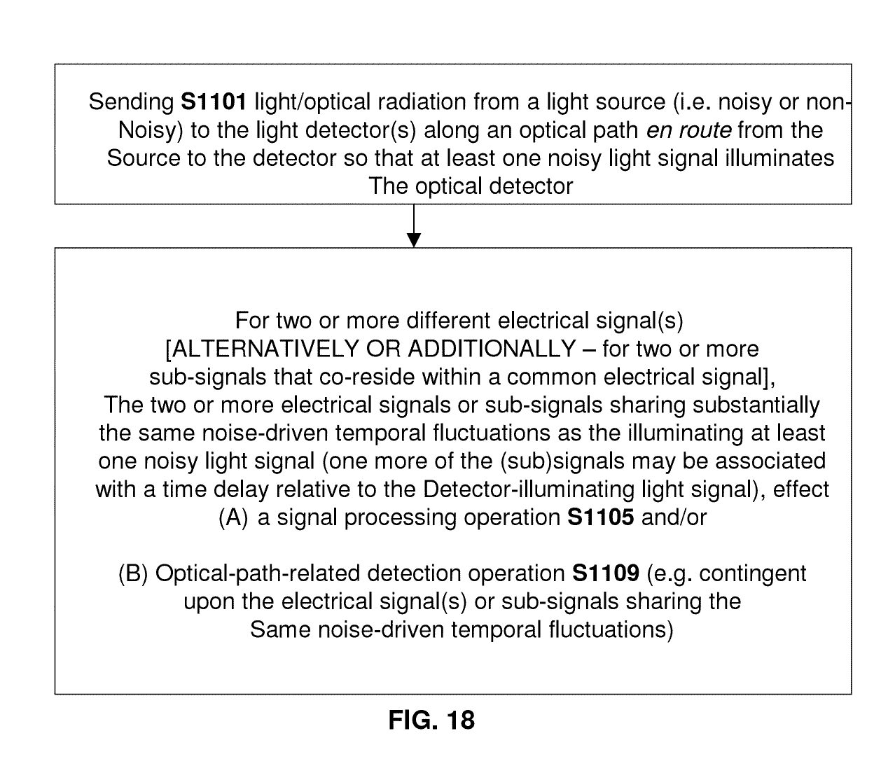

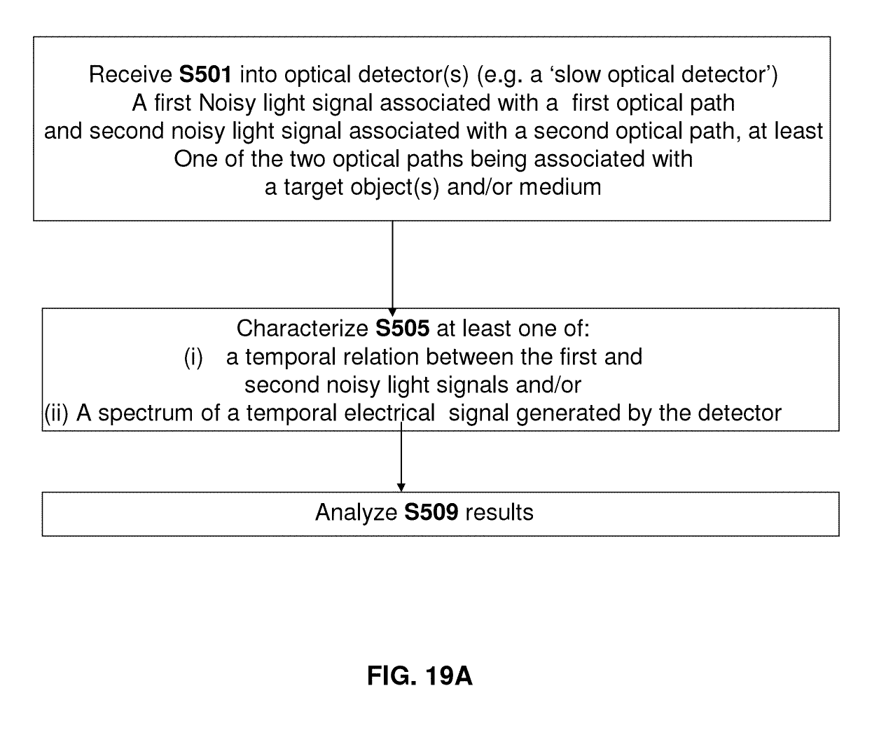

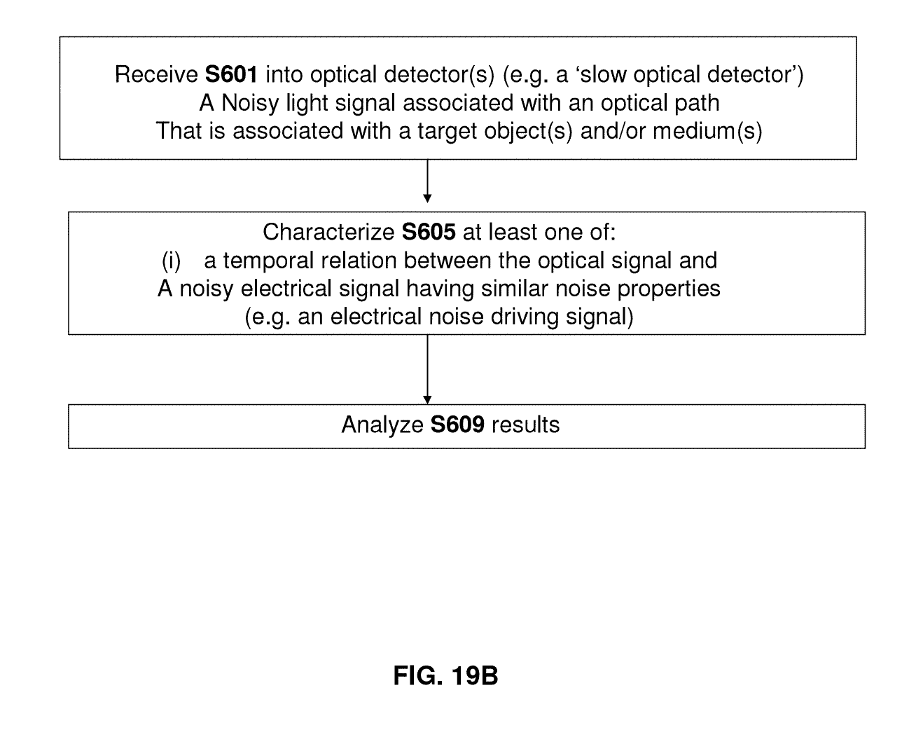

Steps S505 of FIG. 18 and S605 of FIG. 19 may relate to carrying out either the ‘spectral’ or ‘temporal’ technique (or any other technique), and are discussed below.

Although certain embodiments may be explained in the present document in terms of one or the other of the above signal-processing techniques (or any other technique), there is no requirement (unless stated otherwise) that any given system or method is limited to any specific signal-processing technique.

FIG. 1, discussed below, is a flow-chart of a related routine for optically probing an object and/or medium using noisy light detected by a ‘slow’ optical detector. FIG. 1 relates to the specific case of a ‘spectral’ technique for processing a noisy electrical signal descriptive of a noisy light signal.

FIGS. 2-4 relate to systems where multiple noisy light signals are collectively received into the same optical detector as a superimposed light signal (FEATURE A). In some embodiments, despite the superimposition of the noisy light signals, it is possible to computer a parameter contingent upon the distinctness of each of the noisy light signals—i.e. a parameter describing a temporal relationship between multiple noisy light signals.

In FIG. 2, both the noisy source light signal used to illuminate the target and the noisy light response signal received from the target are fed into the same optical detector —neither noisy light signal is detected ‘in isolation’ and the only detection operation is carried out when these noisy light signals are mixed together. As noted above, in noise-radar techniques, it is desirable to measure the cross-temporal-correlation between these two noisy light signals which, in FIG. 2, are not detected separately, but instead are optically mixed so that only the mixture of these two noisy light signals is received into the optical detector.

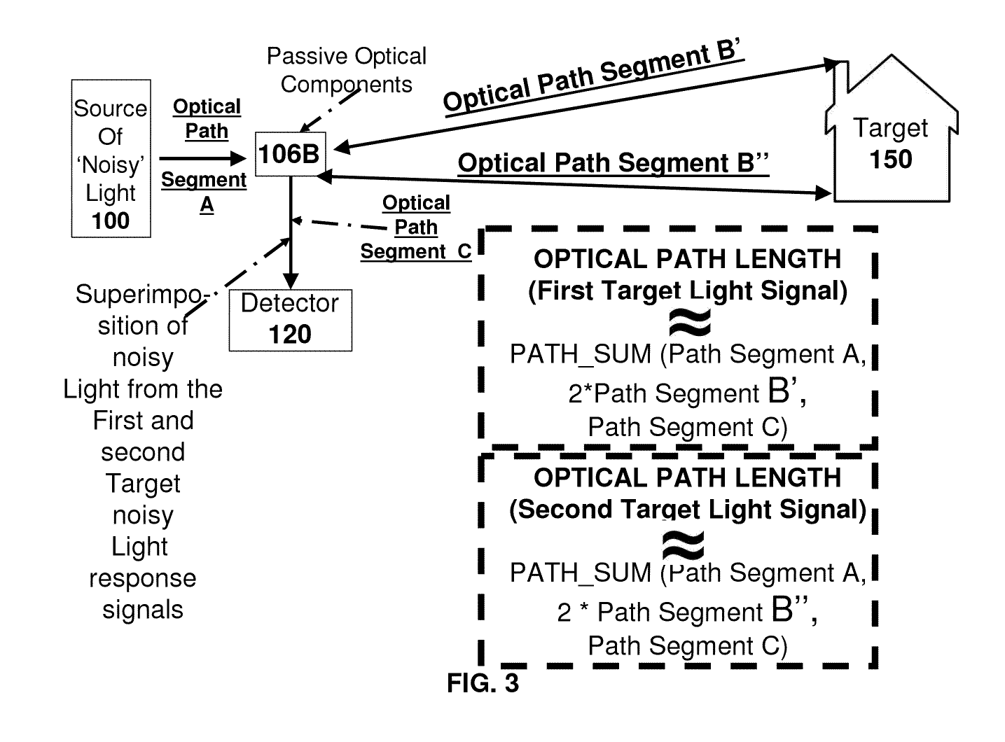

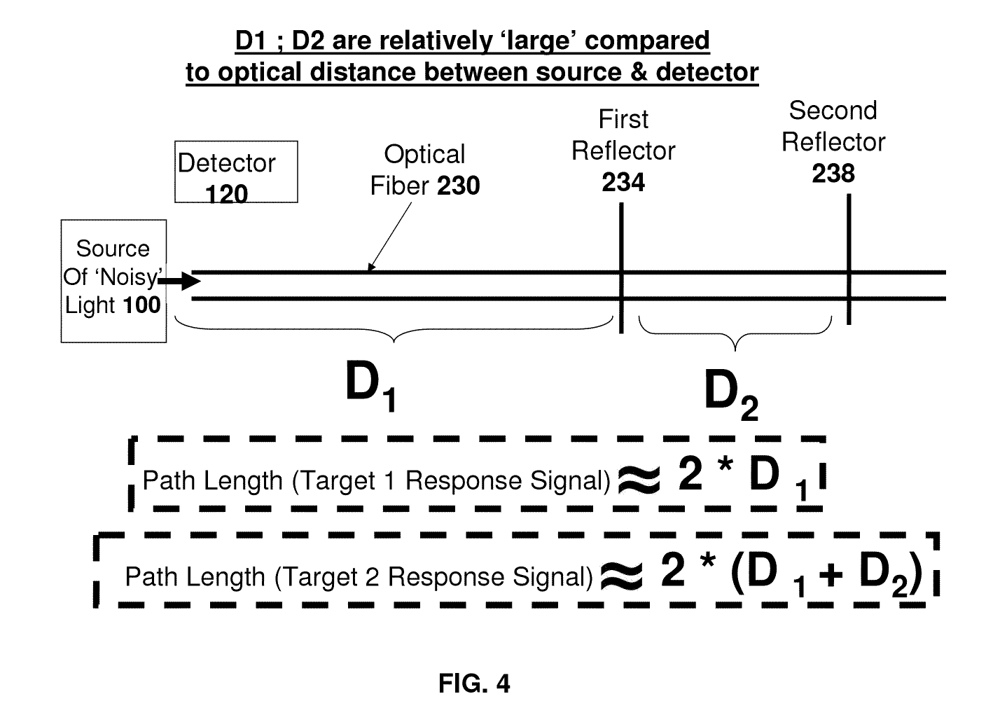

FIG. 2 relates to the specific example of characterizing a temporal relation between a noisy source light signal and a noisy response (or return) light signal from the target even when they are only detected within the same slow detector. This concept is generalized, in various examples below, to other combinations of noisy light signals detected only as a mixture within the same ‘slow’ optical detector—for example, see FIGS. 3-4.

FIG. 5 illustrates a 3-D camera that employs noisy light in order to measure surface properties and/or topographic properties of an imaged object (FEATURE B). In FIG. 5, instead of using a single photodetector, and array of photodetectors are employed —for example, ‘slow’ photodetectors. Although not a requirement, when each photodetector is illuminated with a superimposition of two different noisy light signals whose stochastic behavior is correlated to each other with some sort of time delay, it may be possible to reduce the cost of electronics required to carry out signal processing operations.

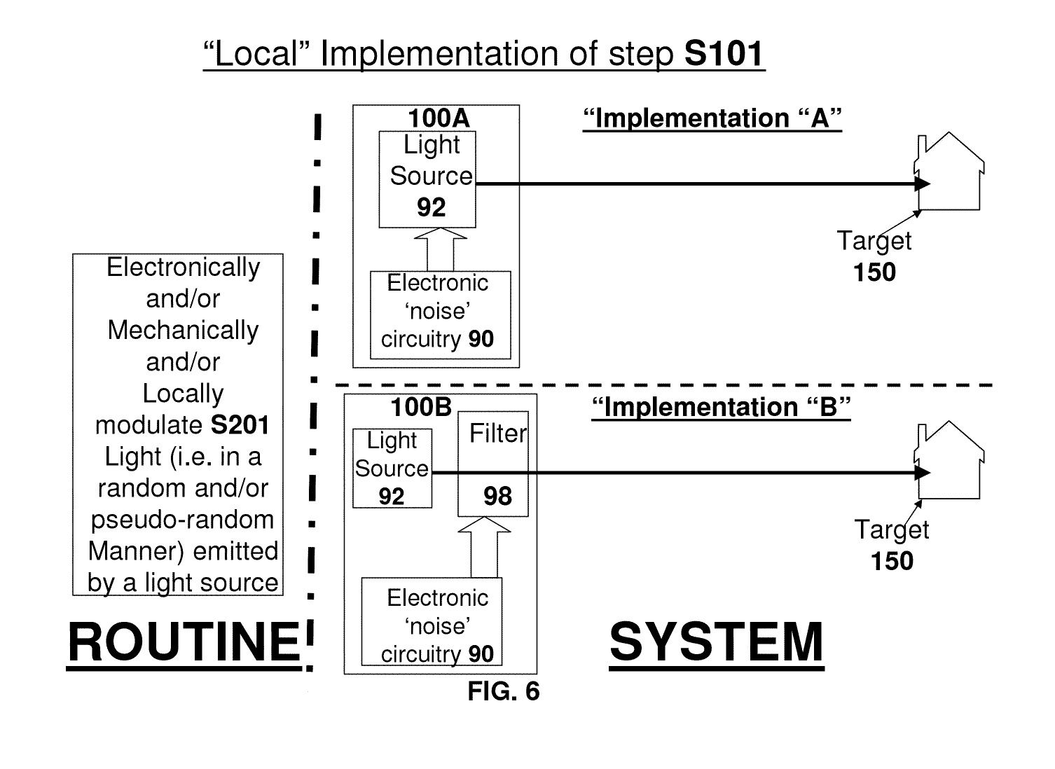

FIGS. 6-7 illustrate different techniques for producing conditions whereby light returning from a target object or medium is ‘noisy’ light that is randomly or pseudo-randomly modulated. In the example of FIG. 6, the input light itself is randomly or randomly or pseudo-randomly modulated.

In the example FIG. 7, the ‘targets’ themselves imbue light with noisy properties (FEATURE C). In one example related to FIG. 7, the light source itself is not noisy, and the instant before light reaches the target, the light is still not noisy. In another example, noisy light illuminates targets of FIG. 7. Although the example of FIG. 7 relates to free space, this is not a requirement, and some embodiments relate to targets within a medium (for example, within a fiber cable) that imbue light with noisy properties.

FIG. 8 relates to a technique for measuring an impulse response (FEATURE D) of a target object(s) or medium using noisy light. In some embodiments, the routine of FIG. 8 obviates the need to generate a short optical pulse in order to measure the impulse response of an object(s) or medium. One non-limiting application of the routine of FIG. 8 is to characterize the length and/or attenuation of an optical fiber and/or to characterize split and/or mated-connector losses and/or break or other faults in the fiber and/or distribution of the light among modes of a multi-mode fiber and/or to characterize mechanical properties of an optical fiber—see FIG. 9 (FEATURE E).

Surprisingly, it is possible to measure the optical impulse response without requiring the generation of a very short pulse. In contrast with optical time-domain reflectometer (OTDR) technique which rely on very short pulses to measure an impulse response and to measure mechanical and/or material properties of the optical fiber, in some presently disclosed embodiments it is possible to measure an impulse response and/or characterize the length and/or attenuation of an optical fiber and/or to characterize split and/or mated-connector losses and/or break or other faults in the fiber and/or distribution of the light among modes of a multi-mode fiber and/or to characterize mechanical properties of an optical fiber without relying on very short pulses.

FIGS. 10-17 relate generally to techniques for measuring a temporal change in an optical path via which noisy light travels (FEATURE G), and more specifically to optical noise-radar-based intrusion detection techniques (FEATURE F).

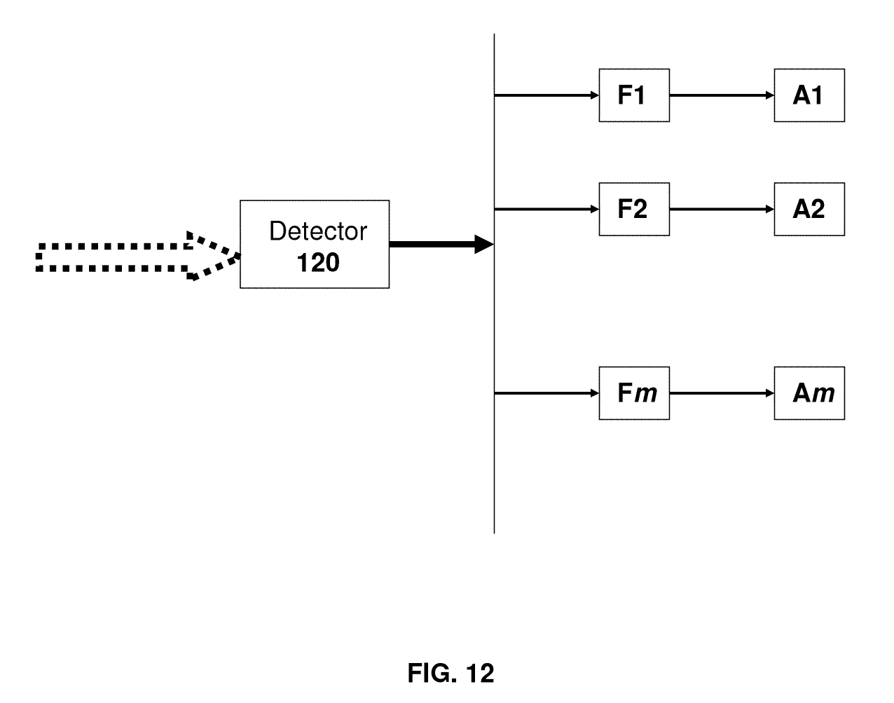

FIG. 10 is a flow chart describing techniques for intrusion detection using noisy light reflected by and/or traverses and/or is deflected by and/or is scattered by and/or is modulated by one or more targets. Non-limiting examples of intrusion detection systems are discussed below with reference to FIGS. 12-17. Some intrusion detection system embodiments relate noisy light travelling within free space, and some embodiments relate to noisy light travelling within fiber optics or within any other medium.

In some embodiments, it is possible to detect mechanical motion of one or more fiber optic cables by monitoring noisy light signals transmitted within the fiber optic cables. In various non-limiting example use cases, optical noise-radar-based techniques for intrusion detection may be used (i) to monitor, in ‘real time’ if a person climbs a fence and moves or otherwise stresses or strains a fiber optical cable attached to the fence and/or to measure a location where the fence is climbed; (ii) if someone sabotages or attempts to sabotage an fluid pipeline (e.g. a pipeline for transporting fuels such as oil or other petroleum products) where a fiber optic cable is mechanically coupled to the pipeline and runs along the length of the pipeline; and/or (iii) to detect sabotage or attempted sabotage of a fiber optical communications cable.

The previous paragraph presented certain fiber-optic-cable related examples related to intrusion detection. This is not a limitation, and in other examples, it is possible to detect intrusion detection in other situations where fiber optic cables are not required.

For many applications, in order to determine a distance-related parameter and/or an impulse response and/or a frequency response and/or an intrusion-related event it is necessary to monitor properties of noisy light received into an optical detector over a continuous spectrum of frequencies. For example, according to the double spectrum technique, after computing an amplitude and/or phase spectrum ] of a temporal electrical signal generated by the optical detector and descriptive of a light signal received including light from the target(s), it is useful to compute an inverse FFT (fast Fourier transformation) of a broad-band spectrum of frequencies in order to measure temporal delays between two different noisy light signals. For example, this technique may be used to measure a temporal relationship between a ‘source light signal’ used to illuminate the target and a return noisy light signal from the target.

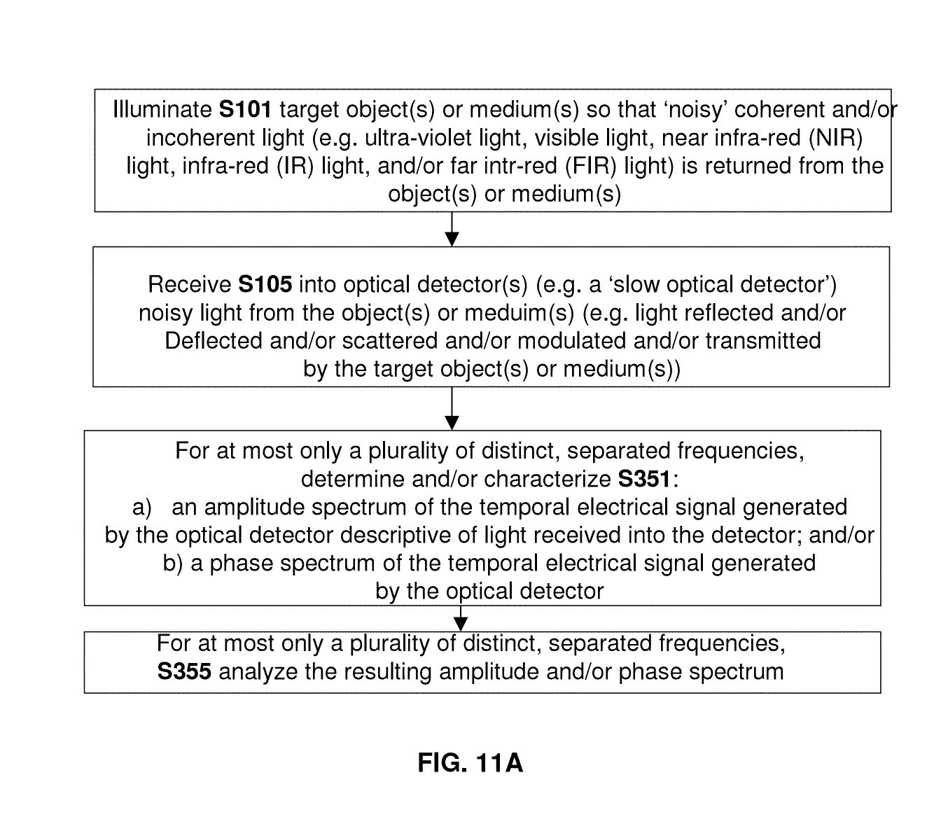

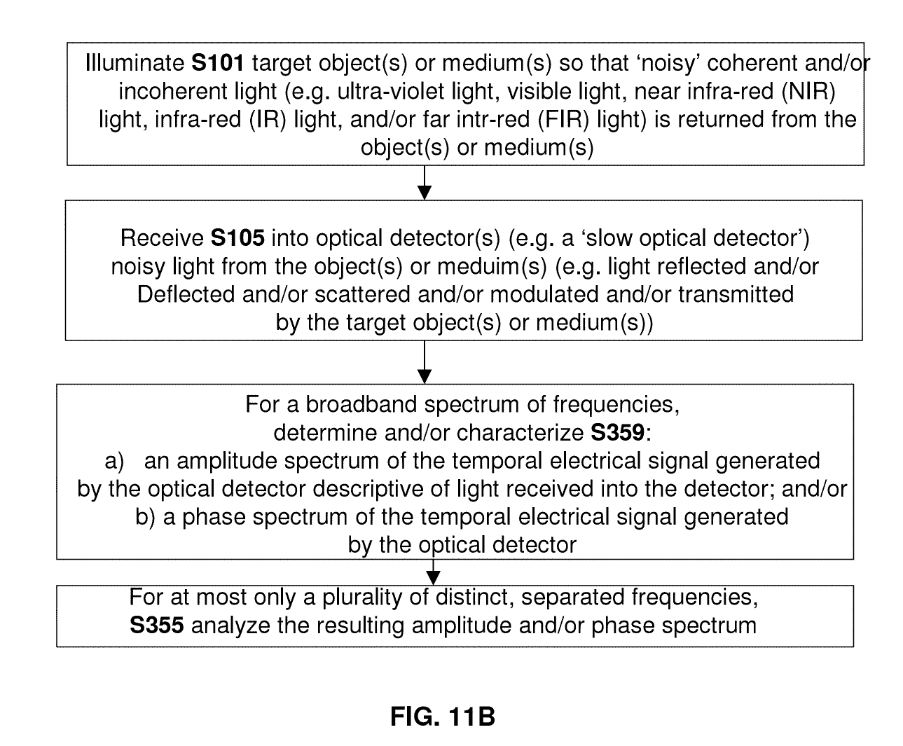

FIG. 11A-11B relate to a ‘discrete spectrum’ routine (FEATURE H) for characterizing a temporal relationship between (i) a first noisy light signal associated with a first optical path (e.g. a ‘source’ light signal) and (ii) a second noisy light signal associated with a second optical path in order to detect a temporal change in an optical path of noisy light (FEATURE G) and more specifically to intrusion detection (FEATURE F).

Instead of measuring a power amplitude and/or phase spectrum for a continuous range of frequencies (e.g. for the purpose of the ‘double spectrum technique’), according to the routine of FIG. 11, it may only be necessary to measure and/or to analyze the amplitude and/or phase spectrum at only discrete frequencies within the spectrum (FEATURE H).

In the example of FIG. 11B, the amplitude and/or phase spectrum is measured for a ‘broadband’ of frequencies—however, the resulting amplitude and/or phase spectrum is only analyzed for a plurality of distinct frequencies. For example, this may obviate the need to compute an inverse FFT that is associated with the double spectrum technique in order to determine a temporal relationship between the first and second noisy light signals.

In the example of FIG. 11A, not only is there no need to analyze the amplitude and/or phase spectrum over a relatively ‘broadband’ of frequencies, but there is no need to even measure the amplitude and/or phase spectrum over the relatively ‘broadband’ of frequencies. For example, it may be possible to use optical or electronic filters and measure the amplitude and/or phase spectra at only a plurality of distinct ‘separated’ frequencies that are separated from each other on the ‘frequency axis.’

FIG. 12 is a block diagram of a system for carrying out routines of FIGS. 11A and/or 11B.

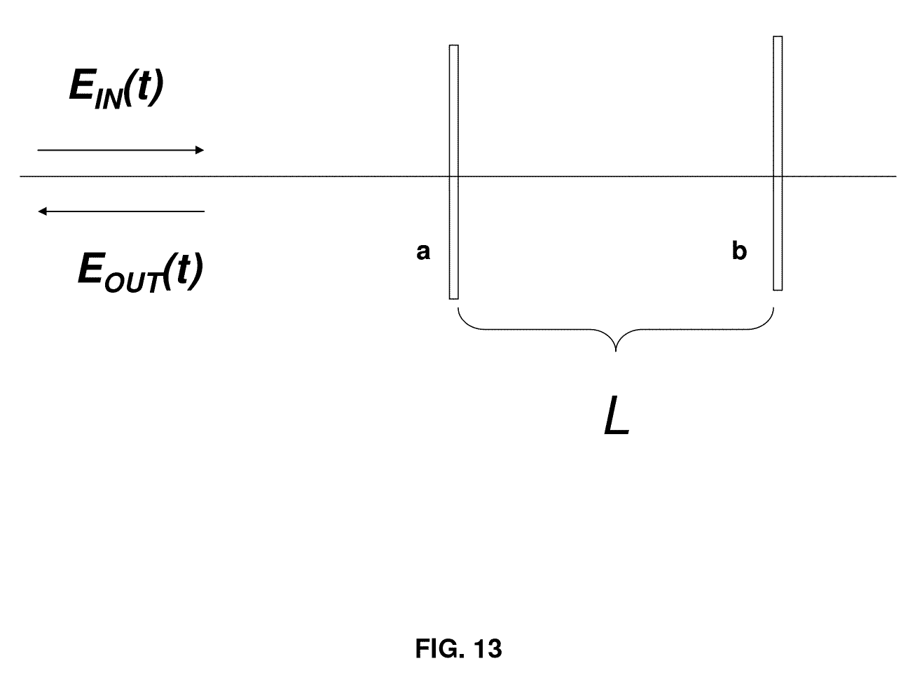

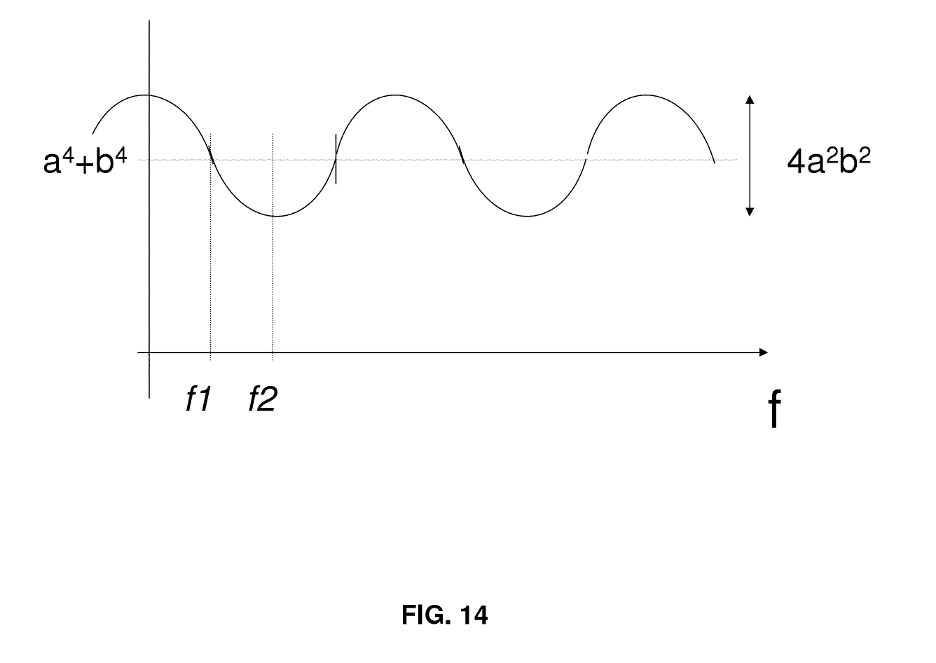

FIG. 13 is a block diagram of portions of an intrusion-detection system that may implement any teaching or combination thereof of FIGS. 11-12. Thus, in some embodiments, it is possible to detect intrusion according to detected patterns at only specific frequencies within the spectrum. FIG. 14 is a graph of a power spectrum density for the case of two reflectors illustrated in FIG. 13.

In the example of FIG. 13, it is possible to monitor the optical path between the left reflector (i.e. having reflectivity a) and the right reflector (i.e. having total reflectivity b which accounts for the effect of both reflectors). In the event that an optical property of this optical path changes (for example, because a person blocks the noisy light traveling on this optical path between the left and right reflectors), this is indicative of an ‘intrusion event.’ In some embodiments, it is possible to implement this intrusion detection technique by only monitoring a discrete spectrum of frequencies, rather than by monitoring a continuous spectrum of frequencies (FEATURE H).

Teaching(s) of FIG. 13 may implemented within an optical fiber, or in a system where noisy light travels through free space or through a medium other than an optical fiber.

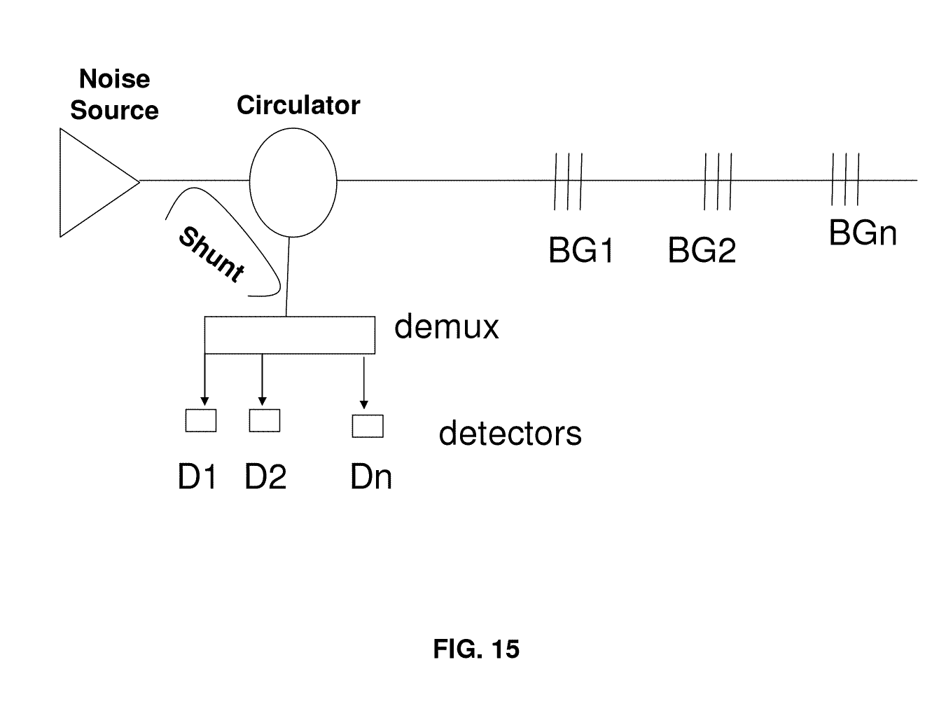

FIG. 15 is a diagram of a system whereby a plurality of spectrally-selective reflectors are deployed at different points in space, and function as a plurality of distinct targets. In some embodiments, FIG. 15 relates to FEATURES F and G. In some embodiments, the behavior of the spectrally-selective reflectors depends on mechanical stress on or at the spectrally-selective reflectors. For example, Brag gratings illustrated in FIG. 15, provide this functionality, though other spectrally-selective reflectors may be employed.

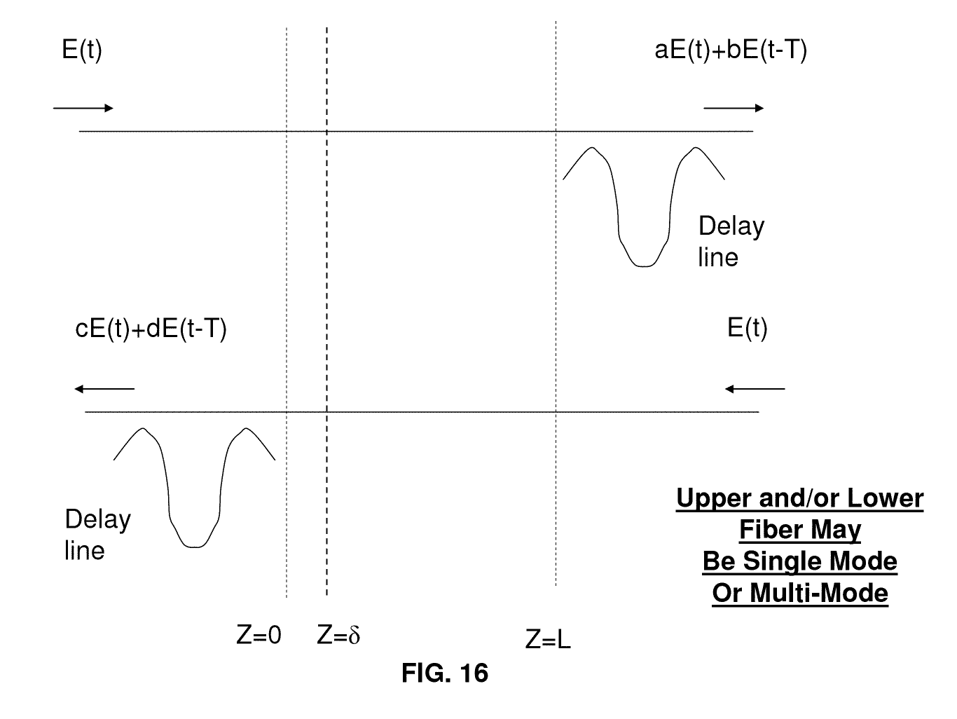

FIG. 16 illustrates a system where in upper and lower fibers are mechanically coupled to each other either directly or via a third object—for example, the upper and lower fibers may be fastened to a fence and oriented substantially horizontally. At some point in time, both the upper and lower fibers are mechanically disturbed (or otherwise modulated) at a particular location Z=delta. In some embodiments, FIG. 16 relates to an intrusion detection technique for determining a value of delta to determine not just the existence of instruction, but its location.

In the system of FIG. 16, in the upper fiber, an optical mixture is generated between (i) the noisy light signal travelling from left to right in a first time reference frame; and (ii) the noisy light signal travelling from left to right in a first time reference frame offset by some time delay. Similarly, in the lower fiber, an optical mixture is generated between (i) the noisy light signal travelling from right to left in a first time reference frame; and (ii) the noisy light signal travelling from right to left in a first time reference frame offset by some time delay.

It is possible to monitor, over time, an autocorrelation of the light signal with a particular delay time. When the upper and lower fibers are simultaneously mechanically disturbed, temporal autocorrelations of the noisy optical signal in both the upper and lower fiber will change—however, they will not necessarily change at the same time. In the event that delta is much closer to Z=0, the temporal autocorrelation in the lower fiber will change at an earlier time than the temporal autocorrelation in the upper fiber. It is possible to measure a location z=delta in accordance with a positive or negative ‘time gap’ between (i) a first time when a temporal autocorrelation of a noisy light signal in the upper fiber changes; and ii) a second time when a temporal autocorrelation of a noisy light signal in the upper fiber changes.

In some embodiments, FIG. 16 relates to FEATURES E, F and G.

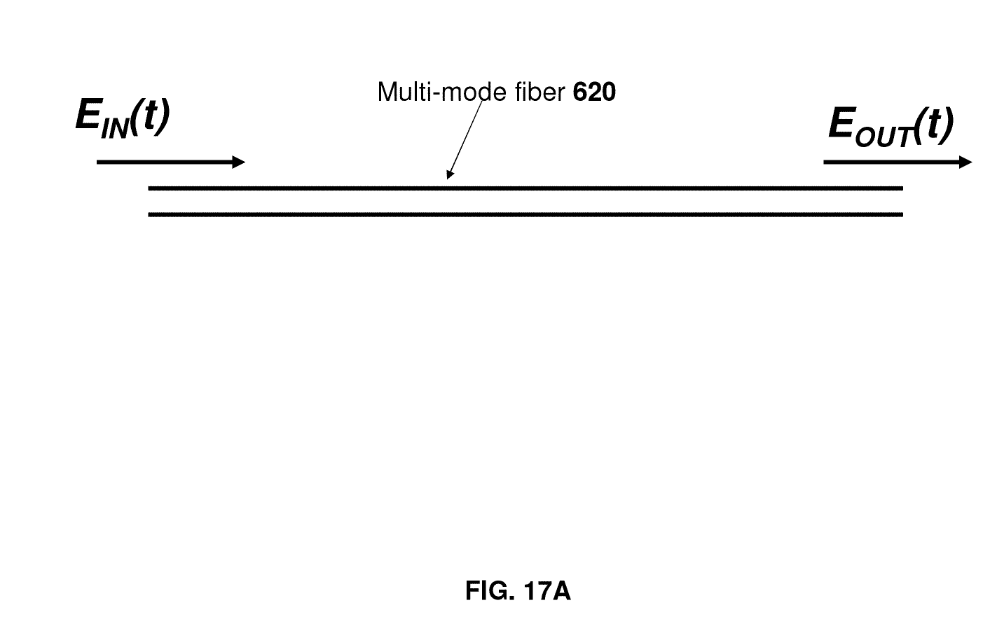

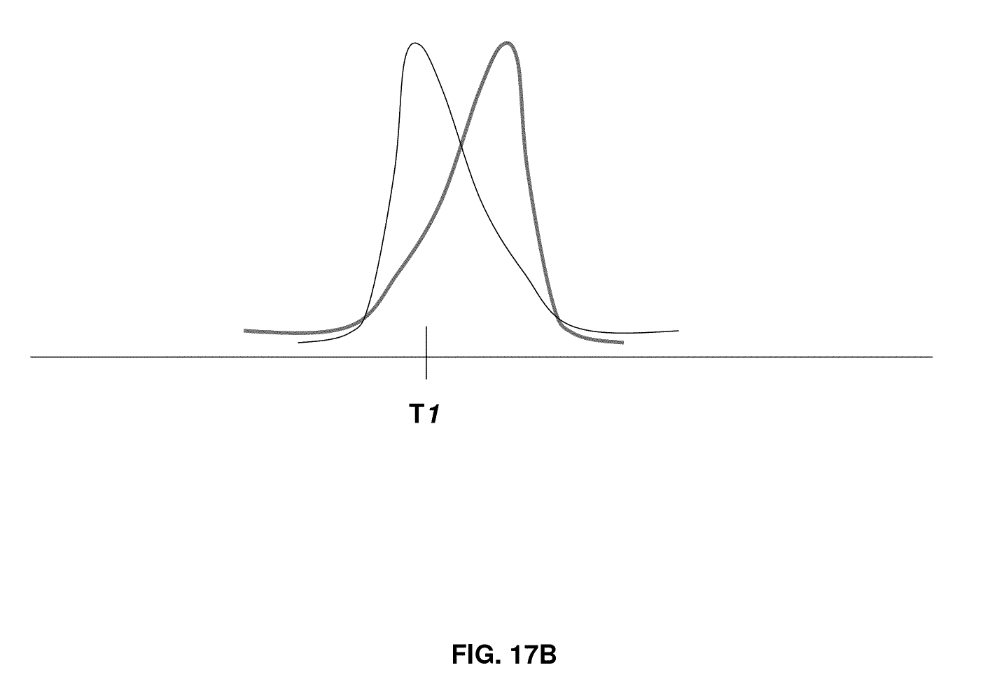

FIGS. 17A-17B illustrates the usage of a multi-mode fiber 620 and optical noise radar to detect a temporal change in an optical path and/or for intrusion detection (FEATURES E, F and G). In the example of FIG. 17, the left-hand pulse is an autocorrelation function that would be characteristic of noisy light that propagates through an unperturbed multimode fiber. Since the light power is distributed among the various fiber modes, where higher-order modes traverse the fiber in a longer path length, the autocorrelation signal consists of a peak having a width characteristic of the difference between the propagation time of the highest mode and the lowest mode, and a peak time T1 characteristic of the power distribution among the modes. If the fiber is perturbed, more of the light is channeled from the lower modes into the higher modes, so that the autocorrelation pulse is skewed to longer delays, as shown in the right-hand autocorrelation peak of the same figure. It is possible to measure an autocorrelation of the noisy light signal—for example, using spectral or temporal techniques. If a force or mechanical stress or strain is applied to the multi-mode fiber (for example, a person places some weight on a fiber attached to a fence), this changes the autocorrelation.

FIGS. 18-19 are routines for optical-noisy-radar techniques for computing physical parameters of a target object(s) or medium(s) according to a temporal relationship between two noisy light signals and/or between a noisy light signal and a noisy electrical signal and/or between two noisy electrical signals. FIGS. 18-19 are discussed in more detail below. In some embodiments, FIG. 16 relates to FEATURES E, F and G.

FIG. 1, discussed above, relates to a specific case of the routine of FIG. 18, whereby (i) a single or double spectrum is employed; and (ii) multiple light signals superimposed on each other simultaneously illuminate the same detector. Thus, FIG. 1 refers to some specific embodiments.

A Discussion of FIGS. 18-19

FIG. 18 is a flow chart of a noisy-light based routine according to some embodiments. In some embodiments, this technique may be used to optically probe an object(s) and/or medium and/or one or more optical paths.

Applications of the technique of FIG. 18 include but are not limited to: (i) measuring distance parameter(s) or time derivatives thereof; (ii) measuring a change in an optical path (e.g. either difference(s) between multiple optical paths) or a transient and/or temporal change in a single or multiple optical path(s); (iii) measuring mechanical and/or material properties of particular medium/media—for example, fiber optic(s); (iv) detection of an intrusion event; (v) acquiring a three-dimensional imager of a scene using a three-D cameras.

In step S1101, a) light (i.e. optical radiation—this may be UV, visible, or any IR such as NIR, thermal IR or far IR) is sent from the light source to the light detector so that the light travels along an optical path en route from the source to the detector so that at least one noisy light signal from the sent light illuminates the optical detector.

The optical path may include and/or contact and/or traverse a target location so that the light is reflected and/or transmitted and/or deflected and/or otherwise modulated at the target location. In some embodiments, the light is noisy before reaching the target location. Alternatively or additionally, the light is imbued with noisy characteristics at the target location.

In different embodiments, there may be one or more than one detector and/or one or more than one target and/or one or more than one optical path.

For example, in FIG. 2, the ‘path’ of step S1101 reaches target 150 and is directed into detector 120 via components to illuminate detector 120—in addition, source light signal is also directed into detector 120 so that more than one noisy light signals are superimposed onto each other to simultaneously illuminate the detector (also see FIGS. 3-4, FIG. 20). In FIG. 2, one of the more than one noisy light signals is a source signal. In FIGS. 2-3, more than one noisy light signals is from targets—one from a first target and the other from a second target.

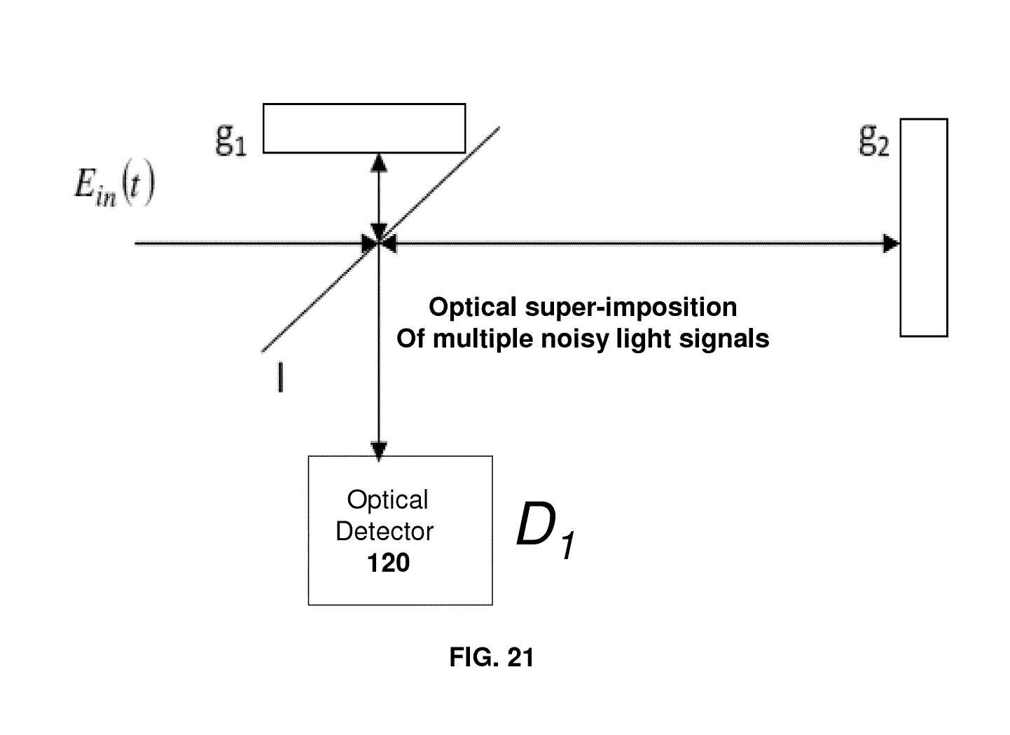

As seen in FIG. 21 (see discussion below), there is requirement for superimposition of light signals, and it is possible for an optical detector to be illuminated only by a single noisy light signal of step S1101.

The noisy signal(s) of S1101 are detected (NOT SHOWN IN FIG. 18) by an optical detector to generate electrical signal. In one example (see FIGS. 1-2), because the light is super-imposed to simultaneously illuminate the detector with more than one noisy light signal, the electrical signal generated by the detector is a combination signal including more than one noisy electrical ‘sub-signal’—for example, each sub-signal may be associated with a light signal from a different respective target (see FIGS. 3-4) or one or more of the sub-signals is associated with the noisy source signal (see FIG. 2). In this case, the light signals are ‘together’ within a single electrical signals.

In step a signal processing operation S1105 and/or an optical-path-related detection operation S1109 is carried out for one or more of: (i) a combination electrical signal in which both sub-signals co-reside and/or (ii) a non-trivial mathematical function of (e.g. sum of, difference of, product of or any other non-trivial mathematical function) of the signals or sub-signals.

In one example, the ‘input’ steps step S1105 and S1109 is the single signal from a detector illuminated simultaneously by the two different noisy light signals as a superimposing. In another example, one of the (sub)signals comes from the noise circuitry 90 without any need for optical diction for the (sub)signal.

In another example (see, for example, FIG. 21), one (sub)signal comes from a first detector D1, while a second (sub)signal comes from a second detector D2.

Signal-processing operations in step S1105 may include characterizing any combination of:

(i) a relationship between power and frequency of any non-trivial mathematical function of the electrical signals or sub-signals over a discrete or continuous spectrum (see, for example, step S109 of FIG. 1; S351 of FIG. 11A or step S359 of FIG. 11B or step S505 of FIG. 19A or step S605 of FIG. 19B);

ii) a temporal correlation function of the electrical signals or a temporal autocorrelation function of the combination electrical signal including the co-residing noisy sub-signals.

Detection operation(s) of step S1109 may include any combination of detecting:
i) a distance parameter(s) involving one or more objects and/or time derivative thereof;
ii) a change in propagation time and/or any other characteristic of at least one optical path and/or physical path including the optical path of step (a) from the source to the detector that illuminates the detector with the noisy light signal (in one non-limiting example, this may be useful for intrusion detection)—this may a static characteristic and/or a dynamic characteristic;
iii) a static or dynamic relation between two or more distinct optical paths at least one of which is the optical path of step (a) from the source to the detector that illuminates the detector with the noisy light signal;
iv) an impulse response of the object(s) of medium;
v) an intrusion event involving the optical path;
vi) a material or mechanical property of an optical fiber, at least a portion of which is included in the optical path of step (a).

In some embodiments, steps S1105 and/or S1109 may contingent upon the different electrical signals or sub-signals sharing substantially the same noise-driven temporal fluctuations (e.g. according to some signal-processing routine for electrical signal(s) or sub-signals)).

In some embodiments, any one of S1105 and/or S1109 may be carried out in accordance with a speed of light (e.g. in a particular medium)—i.e. in accordance with a relationship between a time delay (i.e. throughout the specification the time delay may be positive or negative and may refer to ‘true delay’ or ‘advance in time) and the speed of light—e.g. to determine a distance parameter.

FIGS. 19A-19B, discussed relate to either temporal or spectral signal processing techniques. In the example of FIG. 19B, two or more noisy light signals (i.e. as characterized by one or more detectors that measure the light signals) are subjected to temporal or spectral signal processing in step S505. In the example of FIG. 19B, a noisy light signal and a noisy electrical signal (for example, signal of electronic ‘noise’ circuitry 90 for modulating a light signal to imbue random properties) are processed—e.g. according to temporal or spectral or any other techniques.

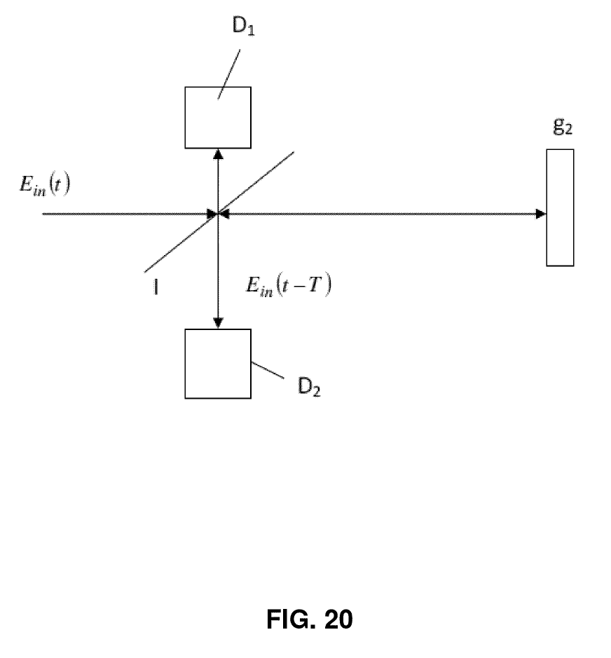

FIGS. 20-24 illustrate block diagrams of various optical noise-radar-related systems.

Embodiments relate to noisy light received from any target and/or noisy light which traverses any medium(s). Teachings disclosed herein may be applied to any object or medium, including but not limited to (i) An optical fiber; (ii) the body of a live animal (e.g. a mammal such as a human) or any portion thereof; (iii) Any type of biological medium; or (iv) Any object or medium that is at least partially obstructed by another object or medium.

### Definitions

For convenience, in the context of the description herein, various terms are presented here. The current section is not intended as comprehensive and certain terms are discussed and/or defined elsewhere in the current disclosure. To the extent that definitions are provided, explicitly or implicitly, here or elsewhere in this application, such definitions are understood to be consistent with the usage of the defined terms by those of skill in the pertinent art(s). Furthermore, such definitions are to be construed in the broadest possible sense consistent with such usage.

For the present disclosure, the term ‘target’ means an object or location to which like is sent from a light source and/or from which noisy light returns in order to illuminate an optical detector.

The terms ‘electrical’ or ‘electronic’ circuitry may be used interchangeably is intended to broadly include any combination of analog or digital circuitry as well as computer-readable readable-code or software.

Electronic circuitry may include may include any executable code module (i.e. stored on a computer-readable medium) and/or firmware and/or hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used including but not limited to reduced instruction set computer (RISC) architecture and/or complex instruction set computer (CISC) architecture. Electronic circuitry may be located in a single location or distributed among a plurality of locations where various circuitry elements may be in wired or wireless electronic communication with each other.

‘Electrically’ or ‘electronically’ carrying out any process or operation(s) can be accomplished using any combination of analog and/or digital circuitry and/or computer code and/or software.

In the present disclosure, the terms ‘light’ and ‘optical radiation’ are used interchangeably.

Embodiments of the present invention relate to ‘optical radiation.’ It is well-known in the art that optical radiation is “subdivided into ultraviolet radiation (UV), the spectrum of light visible for man (VIS) and infrared radiation (IR).” (website of The Federal Office for Radiation Protection, Germany). It is well-known in the art that infrared radiation may be subdivided into near IR, thermal IR and far IR (see Wikipedia, article on ‘Radiation’). It is well-known in the art that the following types of electromagnetic (EM) radiation are not considered optical radiation: ionizing radiation like x-rays or gamma rays and electromagnetic fields such as microwaves and radio frequencies.

In various embodiments, the ‘EM carrier wave frequency’ of the optical radiation exceeds at least 10¹² HZ or at least 5*10¹² HZ or at least 10¹³ HZ or at least 10¹⁴ HZ.

The ‘EM carrier wave frequency’ determines the part of the electromagnetic spectrum specific radiation belongs to. Thus, the ‘EM carrier wave frequency’ of UV light exceeds the ‘EM carrier wave frequency’ frequency of visible light.

The ‘EM carrier wave frequency’ should not be confused with the ‘representative noise modulation frequency’ that is representative of the ‘noise modulation frequency range’ or the ‘bandwidth of the noise modulation.’—The ‘noise modulation frequency range’ is the range of frequencies provided by the noise source, and the representative frequency is a representative central tendency value (e.g. a mean). Similarly, the term ‘noise spectrum’ should not be confused with the ‘EM spectrum’—the ‘noise spectrum’ refers to the variety of modulation frequencies at which noisy optical radiation/light is modulated.

In different embodiments, the bandwidth of noise is: (i) at least 10⁷ HZ and/or at least 10⁸ HZ and/or at least 10⁹ HZ and/or at least 10¹⁰ HZ and/or at least 10¹¹ HZ; and/or (ii) at most 10¹³ HZ and/or at most 10¹² HZ and/or at most 10¹¹ HZ and/or at most 10¹⁰ HZ. Thus, in different embodiments, the ‘characteristic time of the noise’ (i.e. associated with a representative central tendency value (e.g. a mean) of frequencies provided by the noise) is at most 10−⁷ seconds and/or at most 10−⁸ seconds and/or at most 10−⁹ seconds and/or most 10−¹⁰ seconds and/or at most 10−¹¹ seconds and/or at least 10−¹² seconds and/or at least 10−¹¹ seconds and/or at least 10−¹⁰ seconds and/or least 10−⁹ seconds and/or at least 10−⁸ seconds.

When the term ‘frequency’ or ‘spectrum’ or ‘frequency spectrum’ appears without any modification, the skilled artisan should understand whether it the EM carrier wave (i.e. which is UV, or visible or IR) or to the noise source. In case of doubt, it should be assumed that the term ‘frequency’ or ‘spectrum’ or ‘frequency spectrum’ refers to the noise source and/or type of modulation provided in the context of ‘noisy light.’

When light/optical radiation is detected by an optical detector, the optical detector generates an electrical signal whose temporal variations describe temporal variations of the power of the optical radiation illuminating the detector. It is possible to analyze this electrical signal to determine an a power spectrum, amplitude spectrum (the square-root of the power spectrum) and a phase spectrum associated with the frequency spectrum of the electrical signal.

Some embodiments relate to a ‘slow’ optical detector. A ‘slow’ optical detector has a response time (for example, between 10⁻¹¹ seconds and 10⁻⁹ seconds) that is much slower (for example, by a factor of at least 10, or a factor of at least 50, or a factor of at least 100, or a factor of at least 500, or a factor of at least 1,000) than a time scale of a carrier frequency of the ‘high’ frequency noise light (for example, less than 10⁻¹² seconds). The term ‘slow’ is not an absolute term but rather a relative to a characteristic time of a carrier wavelength of specific optical radiation used. For some wavelengths, all optical detectors are, in fact, slow, and there is no technology available today where the optical detectors are fast enough to not be considered ‘slow.’ One salient feature of these slow optical detectors is that they can only measure an average power of light received into the optical detector over a time scale that is much slower than a time scale of the electromagnetic carrier frequency of the optical radiation (i.e. UV or visible or IR light).

Without limiting what is written above, in some embodiments, the optical detector is slower or much slower (for example, by a factor of at least 10, or a factor of at least 50, or a factor of at least 100, or a factor of at least 500, or a factor of at least 1,000) than a ‘characteristic time of the noise’

In some embodiment, the time scale of the optical detector and/or the electronics is greater than a time scale of the noise. This would mean that the optical detector is slower than the noise and/or when analyzing an electrical signal(s) including noise fluctuations, it may be useful to average the electrical signal(s) over a sliding window whose width is at least some fraction of a time scale of the noise (i.e. at least 0.1 times or at least 0.5 times or at least 1 times or at least 1.5 times or at least 2 times or any other value that the skilled artisan would conclude to be useful after reading the present disclosure).

When one or more characteristic(s) of light is modulated randomly and/or pseudo-randomly, this produces ‘noisy light.’ The ‘noise’ can be introduced to the light before the light reaches a ‘target’ or at a location of the ‘target.’ Light characteristics that can by modulated randomly and/or pseudo-randomly include any combination of amplitude and/or phase and/or frequency and/or polarization. Techniques for generating noisy light are discussed below—for example, with reference to FIGS. 6-7. In the example of FIG. 6, the modulation of light to introduce ‘noise’ is carried within or at or near a light source. In the example of FIG. 7, modulation of light to introduce ‘noise’ is carried within or at or near the ‘target.’

The noise-spectral characteristics of ‘noisy light’ are such that the average of the squared amplitude of the frequency spectrum PSDᵢₙ≡|Sᵢₙ(f)|², where PSD stands for power spectral density and Sᵢₙ(f) is the Fourier transform of sᵢₙ(t) is preferably substantially constant over a frequency range from f=0 to f=Δf, where sᵢₙ(f) is the optical power of the optical noise source.

Thus, a ‘flat frequency distribution’ associated with white noise is not required. In some embodiments, this is preferred. In other embodiments, the ‘flat frequency distribution’ may not be present—however, it may be possible to correct for this, for example, if the frequency distribution is known a-priori.

A ‘distance’ parameter refers to the physical distance between two points in any context—for example, a distance between a light source (or detector or any other point outside of an object) and an object(s), a distance between two or more objects, and distance(s) between two or more points on an object. Thus, distance refers to absolute distance and relative distances or any combination thereof. According to this logic, the shape and the size of objects are also considered ‘distance parameters’ since they are characterized by distances between locations on the object. Another example of a ‘distance parameter’ is a surface roughness or surface topography.

A ‘time derivative of a distance parameter’ may refer to an absolute velocity, acceleration or any other non-trivial combination involving any time derivative of the distance parameter. Because the distance parameter defined generally in the previous paragraph, the ‘time derivative’ may refer to translational time derivatives, rotational time derivative, deformational time derivative or any other derivative describing motion of the object(s).

When a target is illuminated with light, the illuminated target generates a light response signal which is sometimes referred to as ‘returning’ from the target. A target ‘responding’ to light refers to any combination of reflection and/or deflection and/or scattering and/or transmission. The term ‘transmission’ in the context of a ‘target’ refers to light being modulated by the target but does not require that light is emitted from the target—i.e. it is understood in the context The term ‘return’ only refers to the light moving away from the target, and does not restrict in any manner any light direction or any relationship between (i) a direction of light before interacting with the target and (ii) a direction of ‘returning from’ the target.

Furthermore, it should be understood that there is no implication in use of the term ‘return’ (or in any other context in the specification) that the light source and the light detector are required to be at the same location (or ‘near’ to each other). Although this configuration is observed in a number of embodiments, this is not at all a requirement, and in some embodiments, the source and the detector and/or more than one source or more than detector can be ‘far’ from each other.

In some embodiments, a ‘target’ is a distinct object. This is not a limitation. In some embodiments, a target may be a region within an object and two targets may actually be within the same object (for example, FIG. 3 relates to two targets that are in the same ‘house’—FIG. 4 relates to a first and second reflectors which are different targets). In another example, the targets may be aerosol particles (for example, in LIDAR-related applications) or may be immersed within a liquid.

An ‘optical path length’ relates to the physical path length and the refractive index of locations through which the optical path traverses. Two optical paths may have distinct lengths because their physical lengths are different or because refractive indexes at any location(s) along the optical paths are different.

When there are two more different or distinct targets, they are separated from each other by some sort of distance. In some embodiments, the ‘minimum separation distance’ for two targets to be considered distinct from each other is at least 0.5 mm or at least 1 mm or at least 2 mm or at least 5 mm or at least 1 cm or at least 5 cm or at least 10 cm. This distance can be a fixed distance or can fluctuate in time. When it fluctuates in time, the distance between the two targets refers to a time when light is incident on both targets to produce a noisy light response signal. In some embodiments, light incident upon each target may be associated with a different optical path. For example, in FIG. 4, light ‘returning from’ a first target 234 is associated with a first optical path (the path length of the first optical path is described in the upper broken rectangle at the bottom of FIG. 4), and light ‘returning from’ a second target 238 is associated with a second optical path (the path length of the first optical path is described in the lower broken rectangle at the bottom of FIG. 4). These two targets are distinct, and as such, are separated from each other by the ‘minimum separation distance.’ Similarly, the optical path of a noisy light ‘returning from’ (i.e. reflected and/or deflected from and/or scattered from and/or caused by any type of modulation from the target) the first target is different from the optical path of noisy light ‘returning from’ the second target.

For two optical paths to be ‘distinct’ or ‘different,’ they can be either ‘physically distinct’ or ‘optically distinct.’ If the two paths are ‘physically distinct,’ a first optical path must include a segment not included the second optical path, where the length of the ‘not included’ segment is at least 0.5 mm. In different embodiments, the length of the ‘not included’ segment is at least 1 mm or at least 2 mm or at least 5 mm or at least 1 cm or at least 5 cm or at least 10 cm. If the two optical paths are ‘optically distinct’ they do not necessarily have to be physically distinct as defined above—for example, the refractive index at one or more locations along the path may be different.

A Discussion of Non-Limiting Examples of Noisy Light

In an embodiment of the invention, the optical EM radiation field has amplitude Eᵢₙ(t) that varies in time in a random or pseudorandom fashion and has a power sᵢₙ(t)=|Eᵢₙ(t)|² that is averaged over the averaging time of the measuring detector and associated electronics. This type of radiation naturally exists, for example, in sources of spontaneous emission as discussed in patent U.S. Pat. No. 5,034,678 (incorporated herein by reference in its entirety), which describes luminescent fiber amplifiers and semiconductor optical amplifiers.

However, this type of radiation also includes other sources of optical “noise” radiation that have not been considered in the past, such as: spontaneous scattering and stimulated scattering e.g., Brillouin scattering and Raman scattering; parametric processes such as sum frequency generation, difference frequency generation, second harmonic generation, and all other types of parametric frequency mixing; and radiation from all types of optical media that are in an excited electronic state. This type of optical radiation can also be generated by modulating the light with a modulator that is driven by a random or pseudo-random electronic signal. The spectral characteristics of this signal are such that the average of the squared amplitude of the frequency spectrum PSDᵢₙ≡|Sᵢₙ(f)|², where PSD stands for power spectral density and Sᵢₙ(f) is the Fourier transform of sᵢₙ(t), the power signal of the optical noise source, is substantially constant over a frequency range from f=0 to f=Δf.

As stated above, a preferred source of EM radiation is one in which the radiation is varying randomly, either due to a natural process or due to an applied modulation. Several types of sources capable of performing this function are known in the art, and others are disclosed herein. For example a suitable source of EM radiation could be one of the following:

1. Amplified spontaneous emission (ASE) source, such as an erbium-doped fiber amplifier, semiconductor optical amplifier, or another type of medium which is in an excited state due to pumping and is emitting spontaneous or stimulated emission;

2. Spontaneous or stimulated scatter of optical radiation, such as caused by Brillouin scattering or Raman scattering;

3. Luminescence or Fluorescence or other type of EM emission from atoms or molecules;

4. Parametric frequency mixing such as sum-frequency generation, difference frequency generation, second harmonic generation or any other type of EM frequency mixing technique due to a nonlinear mixing effect in a suitable nonlinear medium.

5. Amplitude modulation of any light source with a suitable modulator such that the signal is varying randomly, pseudo-randomly, or varying with some other type of modulation such that the spectrum of the source has relatively constant amplitude over the desired spectral width.

6. A light source displaying chaotic variations in light amplitude, such as laser diodes or other lasers having chaotic temporal statistics.

7. Any light source with temporal modulation such that at least half of its power is situated in a spectral band Δf around f₀.

In certain embodiments, the light source is external to the medium to be measured.

In other embodiments, the light source is an integral part of the medium to be studied. For example, an optical fiber will partially scatter injected light in the form of Brillouin scatter and/or Raman scatter, depending upon the optical characteristics of the light source, as is known in the art. These scattering effects cause the light to fluctuate randomly with a characteristic noise bandwidth of approx. 30 MHZ for Brillouin, and significantly broader bandwidth for Raman (typically at least 30 GHZ). In these embodiments, it is possible to utilize the noisy optical radiation to characterize the same optical fiber that is its' source. Applications include: measurement of the fibers' length, strain, stress, temperature, and points of power loss or gain. This description is given as an example only. Any of the previous listed optical noise sources and others known in the art can be utilized to measure certain features of the noise source itself.

It will also be understood that in all of the embodiments, the use of one radiation source is not to be taken as a limitation. All of the embodiments can involve one or more radiation sources, where the noise characteristics of the sources may be fully correlated, partially correlated or have no correlation between them, and where the electromagnetic bandwidth of each of the sources may overlap fully, partially or not at all with each of the other sources.

In some embodiments relate to FIGS. 2-4 and 20, the source of noisy light is labeled with reference number 100.

A Discussion of FIGS. 2-4 and 20

FIGS. 1, 18-19 are flow chart of routines for optically probing an object and/or a medium using ‘noisy’ light in accordance with some embodiments. FIGS. 2-4 and 20 describe exemplary systems in which any routine disclosed herein (for example, the routine of any of FIGS. 1, 19-20) may be carried out in some embodiments.

One salient feature of any of the routines of FIGS. 1, 19-20 is that any routine can utilize only a single optical detector or may utilize more than one optical detector. One salient feature of FIGS. 2-4 is that more than one noisy light signal (i.e. a ‘mixture’ of these light signals) is ‘fed into’ or directed to the same optical detector. In FIGS. 2-4 only a single detector is illustrated—this is not limiting. Some embodiments relate to multi-detector systems and methods where for at least one of the detectors, (i) an optical superposition of more than one noisy light signal is detected by a particular optical detector and (ii) according to the electrical signal generated by the particular optical detector in response to the superimposition of noisy light entering the particular optical detector, a temporal relationship between two or more of these noisy light signals of the optical superimposition is electronically characterized.

In one particular example related to FIG. 5, it is possible to provide an array of optical detectors where each detector of the array detects an optical superimposition of multiple noisy light signals.

FIG. 20 illustrates a ‘multi-detector’ system—in some embodiments, a temporal relation between a first noisy light signal received into a first one of the detectors and a second noisy light signal received into a second one of the detectors is characterized. In a sense, this may be considered ‘easier’ to accomplish, because there is no need to ‘sort out’ noisy light signals that are only detected in combination by a slow optical detector.

Various embodiments refer to ‘first’ and ‘second’ optical or electrical signals—this is not limiting, and it is appreciated that ‘third’ and/or ‘fourth’ or any number of signals may be provided. A ‘plurality’ refers to two or more even when in the present disclosure only the ‘first’ and ‘second’ signal (or any other item) is explicitly described.

FIGS. 1 and 18-19 are flowcharts of routines for optically probing an object(s) or a material(s). In some embodiments, a function of two ‘noisy’ signals determined—for example, between first and second noisy light signals, or between a first signal that is a noisy light signal and a second signal that is a noisy electrical signal, or between first and second noisy electrical signals. As will be discussed below, in FIG. 2 the first noisy signal is a noisy light signal that is substantially the ‘source signal’ while the second noisy signal is a noisy light signal that is received from the target 150. In FIGS. 3-4, the first noisy signal is a noisy light signal received from a first target while the second noisy signal is a noisy light signal that is received a second target. In FIG. 2-4 both noisy signals are received into the same detector. In FIG. 20, first and second noisy signals are respectfully associated with first and second detectors.

In every one of these cases, the stochastic or noise of the first and second noisy light signals are substantially correlated with each other—however, there is a time delay (i.e. constant in time or varying in time) between these noisy signals that temporally fluctuate in substantially the same manner but offset by a time delay . As will be discussed below, it is possible to compute (e.g. see step S113 of FIG. 1, step S509 of FIG. 18 or step S609 of FIG. 19) any number of properties from a temporal correlation function between the first and second signals—for example, a distance to an object, a shape of an object, a distance between more than one object, velocity of an object, acceleration of the object (or any other time-derivative of velocity), properties related to an impulse response, properties related to intrusion diction, and/or any other properties discussed elsewhere in this document.

As noted above, in order to compute a temporal autocorrelation between two noisy signals, spectral or temporal signal processing techniques may be employed in various embodiments. Step S109 of FIG. 1 relates to a spectral signal processing technique. For these ‘spectral’ techniques there is no need to introduce any time delays, and it possible to compare and/or add and/or subject to any other operation two noisy signals without introducing any phase delay. Step S509 of FIG. 18 or S609 of FIG. 19 relate to temporal or spectral techniques.

Reference is now made to FIGS. 2-4. One salient feature of FIGS. 2-4 is that multiple noisy light signals are detected by the same detector. In FIG. 2, noisy light (for example, a beam of light) is transmitted from light source 100. The system of FIG. 2 includes passive optical component(s) 106A configured so that (i) a first portion of the noisy light transmitted from source 100 is directed to detector 120 (i.e. illustrated in a ‘downwards’ direction in FIG. 2) immediately after travelling via ‘Optical Path Segment A’ and a (ii) second portion of the noisy light is directed to the target 150 immediately after travelling via ‘Optical Path Segment A.’ As illustrated in FIG. 2, this light is reflected back from target 150.

Passive optical component(s) 106A is configured so that at least some light returning from the target 150 (for example, a majority of the returning light or substantially all of the returning light) is directed to optical detector 120. As such, optical detector4 120 receives a mixture of (i) a ‘first’ noisy light signal of noisy light which has traversed a first optical path whose length is substantially the sum of ‘Optical Path Segment A’ and ‘Optical Path Segment B’—this noisy light is referred to as the ‘reference light signal’ and is substantially equal to the ‘source signal’ and (ii) a ‘second’ noisy light signal of noisy light which has traversed a second optical path that ‘reaches’ the target and also includes optical path segment B.

The stochastic or noise properties of the first and second signals are correlated with each other—however, there is a constant (or varying) time delay between these noise properties. As will be discussed below, it is possible to compute any number of properties from the temporal relation between the first and second light signals—for example, a distance to an object, a shape of an object, a distance between more than one object, a shape of an object, and additional properties discussed elsewhere in this document. FIG. 3 includes a different set of one or more passive optical component(s) 106B that performs a different functionality from the component(s) 106A of FIG. 2. This functionality is explained below. Passive optical component(s) 106A (or 106B) may include any combination of optical components to perform the functionality illustrated in FIG. 2 (or FIG. 3) in any configuration known in the art to achieve this purpose. Possible optical components include but are not limited to reflectors and/or lenses and/or beamsplitters.

In the example of FIG. 3, passive optical component(s) 106B is configured so that (i) a first portion of the noisy light transmitted from source 100 is directed, immediately after travelling via ‘Optical Path Segment A,’ to a first location on target 150 (i.e. near the top of the house) via optical path segment B′ and (ii) a second portion of the noisy light transmitted from source 100 is directed, immediately after travelling via ‘Optical Path Segment A,’ to a second location on target 150 via optical path segment B″ (i.e. near the bottom of the house). Even though these two locations are on the same house ‘target,’ the location at the top of the house is referred to as the ‘first target’ and the locations at the bottom of the house is referred to as the ‘second target.’

Passive optical component(s) 106B is configured so that at least some light returning from the first and second targets is directed to optical detector 120. As such, optical detector 120 receives a mixture of (i) a ‘first’ noisy light signal of noisy light which has traversed a first optical path that contacts the top of the house and includes Path Segment B′ and (ii) a ‘second’ noisy light signal of noisy light which has traversed a first optical path that contacts the top of the house and includes Path Segment B″.

In the example of FIG. 4, light from the ‘source’ 100 of the noisy light is fed into an optical fiber 230 and travels through the fiber from left to right. First reflector 234 is a partial reflector so that a first portion of the light which reaches the first reflector 234 is reflected backwards and travels from right to left, while a second portion of the light which traverse the first reflector. This second portion is reflected backwards by second reflector 238 and travels from right to left. The reflected light eventually reaches optical detector 120—for example, the system of FIG. 4 may include one or more passive optical component(s) (not shown) for

In FIG. 4, optical detector 120 receives a mixture of (i) a ‘first’ noisy light signal of noisy light which has traversed a first optical path that only reaches the first reflector 234 and does not reach the second reflector 238; and (ii) a ‘second’ noisy light signal of noisy light which has traversed a second optical path that reaches the second reflector 238

FIGS. 2-4 relate to ‘FEATURE A’ where more than one noisy light signal is received simultaneously into the same optical detector—e.g. a ‘slow’ optical detector. As with any other feature disclosed herein, it is understood that FEATURE A is only provided by some embodiments,

In FIG. 20, a noisy light signal Eᵢₙ(t) travels from left to right and at least a portion of the noisy light signal is reflected backwards by a reflective target g2 to reverse a propagation direction from left-to-right into right-to-left. Noisy light reflected back from the target g2 is received into the ‘lower’ optical detector’ D2 and noisy light of the source signal is received into the ‘upper’ optical detector D1. There is no need to mix noisy light from these two signals—instead, it is possible to process detector-generated electrical representations of the noisy light signals that are separately received into the different detectors D1, D2. As is illustrated in the figure, the two noise light signals are substantially identical except for some time delay T.

The two electrical signals may be subjected to any signal processing technique including but not limited to temporal techniques and spectral techniques.

A Discussion of FIG. 1 Relating to Spectral Signal Processing Techniques

FIG. 1 is a flow chart of a technique for optically probing an object(s) or medium(s) where an optical and/or electronic signal descriptive thereof is processed using a spectral technique.

In step S101, a ‘target’ object(s) or medium(s) is illuminated using ‘noisy’ coherent and/or incoherent ‘high frequency’ light which may include any combination of ultraviolet and/or visible and/or near infra-red (NIR) and/or infra-red (IR) and/or far infra-red (FIR) spectra light. In some embodiments, an apparatus including a noisy light source (for example, see 100 of FIGS. 2-4 or FIG. 6) is employed. In other embodiments, a light source 90 which is not necessarily noisy illuminates the target(s) which may be randomly excited (see FIG. 7). In both cases, the light that is ‘returned’ from the target is ‘noisy’ light.

In yet another example (not shown explicitly in the figures), the illumination is provided by ambient light—for example, sunlight. In this example, it is not necessary for the ‘illumination’ to be carried out by any apparatus—this illumination could be provided by nature.

In some embodiments, the illuminating light travels to or from the target in substantially free space. Alternatively or additionally, at least a portion of the light illuminating light may travel via a medium—for example, an optical waveguide such as an optical fiber.

After the target is illuminated, the target responds by reflecting and/or deflecting and/or scattering the illuminating light and/or modulating the illuminating light as it traverses the target or a portion thereof. The result of the target's response is a ‘returning light signal’ of noisy light which is received into one or more optical detectors in step S105. In FIG. 2, this ‘returning light signal’ comes from the house 150 to the left via optical path segment B. In FIG. 3, there are two ‘returning light signals’—a first returning noisy light signal coming from the top of the house 150 via optical path segment B′ and a second returning noisy light signal coming from the bottom of house 150 via optical path segment B″. In FIG. 4, there are two ‘returning’ noisy light signals—a first returning signal coming from the first reflector 234 and a second returning signal coming from the second reflector 238.

In step S105, returning light signal(s) are received into detector 120. As noted throughout this document, in some examples, the same detector receives more than one light signal, and the more than one returning light signal(s) are received together (see FIGS. 3-4) and/or a returning light signal(s) is received in combination with another noisy light signal (e.g. the source signal as in FIG. 2).

In other examples there is no need (for example, in step step S105) to superimpose multiple noisy light signals onto the same detector to simultaneously illuminate the same optical detector 120. For example, in FIG. 20, one detector D1 detects the noisy source signal, while the other detector D2 detects the noisy return signal from target g2. In this example, the return signal has the same (or almost the same) noise characteristics, but is delayed but some time T that describes (i.e. together with a speed of light) a distance to the target g2.

In step S105, the optical detector 120 generates a temporally-fluctuating electrical signal (e.g. analog and/or digital signal) descriptive of the temporal fluctuations in the local light field and/or light power level at the location of the optical detector. Because the local light field and/or local light power level at the location of the optical detector includes the noisy returning light signal, the electrical signal generated by the detector is also ‘noisy.’

In step S109 of FIG. 1, the contents of the temporally-fluctuating electrical signal (i.e. analog and/or digital signal(s)) descriptive of a light signal received into detector(s) 120 is processed to determine and/or characterize an amplitude spectrum and/or a phase spectrum. As noted above, some embodiments relate to ‘spectral-related’ routines—however, in other embodiments, other processing techniques may be used.

Appropriate apparatus for carrying out step S109 includes but is not limited to an electronic spectrum analyzer, analog and/or electronic circuitry (e.g. an analog and/or digital electronic computer(s)), and/or an electronic correlator circuit(s). In some embodiments, it is possible to employ any combination of FFT techniques, and/or wavelet technique(s) any other technique known in the art.

In step S113, the amplitude and/or phase spectrum determined in step S109 is analyzed. One exemplary implementation of step S113 relates to the so-called ‘double spectrum technique’ known in the art of RF noise radar.

The non-limiting example of FIG. 20 may be implemented using spectral and/or temporal techniques. In one example relating to spectral techniques, it is possible to characterized noisy ‘input’ light from a light source and/or noisy light returning from a target. In a specific example related to charactering a noisy source light signal, and relating to FIG. 20, an noisy light spectrum is characterized, by acquiring sᵢₙ(t) as the output of detector D₁ on which the “noisy” optical field is directed and then analyzing its spectrum PSDᵢₙ with the aid of an ESA or other electronic means, where, the detector and associated electronics having a spectral response that covers the range of at least Δf. In this embodiment, a portion of the radiation illuminates the EM medium to be analyzed, and the radiation returning from the EM medium after reflection, transmission, or some other deflection angle is monitored in step S109 of FIG. 1 with a similar detector D₂, where both detectors are characterized by a spectral range that is preferably at least Δf, so that the signal exiting the detector has a power sₒᵤₜ(t) and PSDₒᵤₜ which can be determined using an ESA or other suitable electronic means. A comparison of PSDₒᵤₜ to PSDᵢₙ, such as the transfer function PSDₒᵤₜ/PSDᵢₙ, will give a characteristic spectral transfer function PSD_{medium} of the EM medium, with extremely high resolution.

Phase Retrieval Algorithm

In some embodiments, it is possible to employ a so-called phase-retrieval algorithm in step S109 of FIG. 1

Embodiments of the invention comprise applying a phase retrieval algorithm on the amplitude of the PSD spectrum to determine the phase spectrum associated with the PSD spectrum embodiment associated with the object or medium. These embodiments can further comprise determining the full complex optical power frequency response of the object or medium from the amplitude spectrum and the phase spectrum of the power transfer function spectrum in which case the method can further comprise performing an inverse Fourier transform of the full complex optical power frequency response to determine the optical power impulse response of the object or medium.

A Discussion Relating to Some Embodiments Where a Second Spectral Operation of a Double Spectral Technique is Implemented in Step S113 of FIG. 1

In some embodiments related to the ‘double-spectral technique,’ in step S109 the first spectrum is computed, and in step S113, the second spectrum is computed (for example, by an inverse FFT) to compute an autocorrelation function that may peak at a time gap indicative of the travel time between the source and target (or relative distance of two targets). This information, together with speak of light information, may provide distance indications.

Thus, in some embodiments, it is possible to determine the relative distances between the locations on the medium which are the sources of the radiation returning to the detector. This can be determined directly by the spectral transfer function, or, for example, by calculating the inverse Fourier transform of PSD_{medium} which gives a temporal correlation signal which peaks at temporal locations where the returning radiation originates, or by other means, such as that described as follows:

The correlation between the two power signals sᵢₙ(t) and sₒᵤₜ(t) is directly determined in a fashion known in the prior art by mixing the two signals in an appropriate mixing circuit while scanning the time delay τ of the reference signal sᵢₙ(t−τ) with respect to the optical signal from the target sᵢₙ(t−T). This gives a peak correlation at times τ=T from which the distance to the target can be determined.

When the characteristics of the optical power frequency response of the object or medium are determined in this manner, the inverse Fourier transform of the amplitude squared of the power transfer function is calculated. From the inverse Fourier transform a temporal correlation between the power signals of the illuminating radiation and the returning radiation is determined and from this correlation one or both of the following are determined: the distance from the measurement system to the locations on the object or medium from which the radiation returning from the object or medium originates and the relative distance between locations on the object or medium from which the returning radiation originates.

Some embodiments of the present section related to a situation where in step S109 the first spectrum is computed, and in step S113, the second spectrum is computed (for example, by an inverse FFT).

Alternatively or additionally, the spectrum information computed in step S109 may be processed using other signal-processing routines, and there is no need to always effect a double spectrum technique.

A Mathematical Discussion Relating to ‘Feature A’—for example, as implemented in any of FIGS. 2-4 and/or FIG. 13 and/or FIG. 21

In all of FIGS. 2-4, 13 and 21, a plurality of noisy light signals are superimposed and detected by an optical detector which is simultaneously illuminated by all light signals.

It is shown in these embodiments described above and further described below. that despite the fact that the signal is optical and the detector is ‘slow” relative to the EM field fluctuations, it is possible to measure important spectral and temporal characteristics of the medium's response to optical power signals, as well as its' distance to the measurement system and the locations of multiple reflections in the target medium, by analyzing the power signals associated with the noisy EM field with no requirement to analyzed the EM fields.

Not wishing to be bound by any theory, in this section, a mathematical discussion of scattering of “noisy” EM, its detection by a “slow” detector, and the conclusions regarding analysis of this system using well-known linear system characterization methods are presented.

Given two EM field E_{in,1}(t) and E_{in,2}(t) having power signals s_{in,1}(t)=|E_{in,1}(t)|² and s_{in,2}(t)=|E_{in,2}(t)|² respectively.

Suppose the medium consists of multiple scatterers and is illuminated with E_{in,1}(t). In this case, the output EM field is composed of the sum of the scattered fields from each scatterer:

$${E}_{out , 1} ( t ) = {\sum }_{n}^{ } {a}_{n} {E}_{in , 1} ( t - {T}_{n} ) ,$$

where Tₙ are time delays caused by the scatterers and aₙ are the corresponding coefficients.
The corresponding output power is then

$$\begin{matrix}{s}_{out , 1} ( t ) = {\vert {E}_{out , 1} ( t ) \vert}^{2} = {\vert {\sum }_{n }^{ } {a}_{n} {E}_{i n , 1} ( t - {T}_{n} ) \vert}^{2} \\ = {\sum }_{n}^{ } {\vert {a}_{n} \vert}^{2} {s}_{in , 1} ( t - {T}_{n} ) + {\sum }_{n , m}^{ } {a}_{n} {a}_{m}^{*} {E}_{in , 1} \\ ( t - {T}_{n} ) {E}_{in , 1}^{*} ( t - {T}_{m} )\end{matrix}$$

However, if the medium varies in time, and/or if the EM field varies randomly in time, so that the interference term (the right-hand term) is zero after a suitable averaging time, then

$$〈 {s}_{out , 1} ( t ) 〉 = {\sum }_{n}^{ } {\vert {a}_{n} \vert}^{2} 〈 {s}_{in , 1} ( t - {T}_{n} ) 〉 .$$

As a consequence the medium acts as a linear system for the average power. This can be seen as follows by checking that superposition holds in this system:
If the medium is illuminated with two fields such that

[symbol]

sᵢₙ(t) [symbol] =A [symbol] s_{in,1}(t) [symbol] +B [symbol] s_{in,2}(t)

[symbol]

### Then

$$〈 {s}_{out} ( t ) 〉 = A {\sum }_{n}^{ } {\vert {a}_{n} \vert}^{2} {s}_{in , 1} ( t - {T}_{n} ) + B {\sum }_{n}^{ } {\vert {a}_{n} \vert}^{2} {s}_{in , 2} ( t - {T}_{n} ) = A 〈 {s}_{out , 1} ( t ) 〉 + B 〈 {s}_{out , 2} ( t ) 〉$$

which agrees with the superposition criterion. In addition, if the medium is time-invariant, then it can be characterized by the well-known principle of linear time-invariant (LTI) systems:

[symbol]

sₒᵤₜ(t) [symbol] =hₚ(t)* [symbol] sᵢₙ(t)

[symbol]

Sₒᵤₜ(f)=Hₚ(f)·Sᵢₙ(f)

where hₚ(t) is the power impulse response for the medium, Hₚ(f) is its' Fourier transform, Sₒᵤₜ(f) is the spectrum of sₒᵤₜ(t), and all the conclusions related to LTI systems can be applied here including the use of Fourier transforms and inverse-Fourier transforms which connects between the temporal power response and the spectrum of the power signal, as well as the use of the Kramers Kronig or other phase-retrieval analyses to determine the phase spectrum associated with Hₚ(f).

The spectral response of the specific embodiment that is shown in FIG. 21 is now analyzed. The system shown schematically in FIG. 21 is an embodiment that can be used, for example, for measuring the distance to a target as well as the relative distances between the locations on the target from which returning radiation originates, if more than one location exists. It utilizes only one detector, which is advantageous as compared to the use of two detectors, in terms of complexity, cost, and the complications that arise from the varying characteristics of the two detectors

Reference is made to FIG. 21. In FIG. 21, the “noisy” radiation Eᵢₙ(t) is split by a beam splitter 1 into two beams. One beam is directed towards a “reference” reflector g₁ and the other to a target g₂, both of which reflect a portion of the radiation back towards beam splitter 1 where the reflected beams are combined to form the output beam Eₒᵤₜ(t). Therefore,

Eₒᵤₜ(t)=p₁Eᵢₙ(t)+p₂Eᵢₙ(t−T),

where T=2δL/c is the relative time-lag for the arrival at beam splitter 1 of the beam reflected from g₂ with respect to that arriving from g₁ due to a difference in propagation distance δL to the two elements, and p₁ and p₂ are the effective transmission coefficients of the beams through the system.

For the reasons discussed above, if the radiation is varying randomly in time, then the output power will be the sum

sₒᵤₜ(t)=|ρ|²(sᵢₙ(t)+sᵢₙ(t−T)),

where for simplicity it is assumed that |p₁|²=|p₂|²=|ρ|². This is the power that is measured with a detector having a suitable electronic bandwidth, where due to the time-response of the detector, it performs an averaging as well, so that the above represents the power after the averaging.
The Fourier transform of this signal is:

Sₒᵤₜ(f)=|ρ|²Sᵢₙ(f)(1+e^{-2πfT}).

Therefore in this case PSDₒᵤₜ for the sum of the two signals is:

PSD_{out,sum}≡|Sₒᵤₜ(f)²=2|ρ|²|Sᵢₙ(f)|²[1+cos(2πfT)], equation [1]

such as is measured with an electronic spectrum analyzer.

Note that the spectrum is sinusoidal, with a period that is dependent upon the distance between the two reflectors due to the time delay T. In order to acquire at least one cycle of this spectrum, it is necessary to measure the signal with an electronic bandwidth of approximately Δf=1/T=c/2δL. For example, for δL=10 cm, a bandwidth of 1.5 GHz is needed to acquire one full cycle of the spectrum This information can then be used to determine the distance to the target, since the distance to the reference reflector g₁ is known. This model only treats the case of one reflection location on the target; however it can be extended to the case of more than one location, so that these locations can be determined as well.

In many situations it is sufficient to acquire the spectrum over a portion of the bandwidth Δf. This will reduce the electronic and detector bandwidth requirements accordingly, and will allow for increasing the detectors' active area, so that it will be more sensitive. For example, if the number of reflections from the target is known a priori, then it is possible through appropriate signal analysis, estimation and extrapolation techniques to measure the PSD_{out,sum} over a bandwidth that is smaller than Δf and still acquire knowledge of distance with a depth resolution δL that approx. corresponds to Δf

Therefore, in a variation of the embodiments described herein above, only a portion of the spectrum is measured by utilizing a bandwidth less than Δf. For example, in the case of one reflection from the target, only a portion of the sinusoidal cycle is measured, and the cycle period is determined through known signal estimation techniques and other signal analysis techniques. The ability to utilize a bandwidth less than Δf is advantageous since it relaxes the speed requirements on the detectors and other electronic components of the system.

It is pointed out that the power signal PSD_{out,sum} can also be obtained using other configurations—for example, see FIG. 21 where there is no requirement to detect an optical superimposition of noisy light signals that simultaneously illuminate the same optical detector. In this embodiment sᵢₙ(t) is measured with detector D₁, and sₒᵤₜ(t) with detector D₂. The power signal PSD_{out,sum} is then acquired by summing the detector outputs with a suitable electronic means, such as an electronic summing circuit.
In another variation of embodiment using only one detector, a further inverse-Fourier transform is performed on PSD_{out,sum} described in equation 1 to determine the correlation between the power signals returning from the target and that of the irradiation, which shows a characteristic peak at the time delay T, from which the distance to the target can be determined. As explained above, if more than one source of returning radiation exists on the target, their locations can be identified as well with this technique.

A Further Discussion of FIGS. 5A-5B

FIGS. 5A-5B relate to embodiments where a digital image is generated such that each pixel is associated with a respective optical-noise-radar distance measurement. In some embodiments, each photodetector of an array of photodetectors is associated with a different pixel and may be employed to detect both (i) color and/or grayscale at a location in the scene; and (ii) depth in the location at the scene according to any optical-noise-radar technique disclosed herein.

In the example of FIG. 5B, it is possible to map the 3D topography of a target area by scanning a beam of noisy light transversally over the surface of the target and mapping the variations in the contour of the target. Instead of measuring one pixel of the target area at a given time, the whole or part of the transverse area of the target can be illuminated at once, and the returning radiation detected by one or more detectors, each of which monitors the radiation returning from one of the pixelated areas of the target surface. In a particular embodiment, these multiple detectors are situated in an array format. This description of the detection system is relevant for any of the embodiments described herein.

FIG. 5A illustrates a 2D array 170 of optical detectors 120 as part of a 3D digital camera.

Thus, some embodiments relate to apparatus for acquiring a digital image of a scene comprising: a) a noisy light source 100 (not shown in FIG. 5B) configured to generate optical noisy optical radiation/light, the noisy light being randomly or pseudo-randomly modulated, thereby illuminating a plurality of different scene locations within the scene to induce noisy light response signals from the different scene locations within the scene; b) an image sensor 170 including a substantially-planar two-dimensional array of photodetectors; c) optical components (NOT SHOWN—e.g. passive optical components—for example, lenses, reflectors, and/or any other components known in the art of optics or photography) configured to focus or re-direct noisy light received from the scene onto or to the image sensors, the optical component(s) and the image sensor being configured so that each photodetector of the two-dimensional array: i) receives a different respective noisy response signal from a different respective scene location; ii) generates a different respective temporally-fluctuating electrical signal that respectively the respective noisy response signal from the respective scene location; d) electrical circuitry (NOT SHOWN—e.g. including any combination of analog and/or digital circuitry and/or software) configured to compute from a temporal power spectral density data or a temporal autocorrelation data of the temporally-fluctuating electrical signals generated by the photodetectors, a three-dimensional digital image including a plurality of pixels corresponding to the locations in the scene, each visually pixel representing depth data and grayscale or color data at respective location.

In general, there is no requirement to include the ‘technology’ of FIGS. 2-4, 21 whereby optical detectors (i.e. photodetectors) are simultaneously illuminated by more than one noisy light signal. However, in some embodiments, it may be useful to incorporate this feature.

Thus, in some embodiments, each photodetector 120 of the two-dimensional array 170: i) is respectively illuminated by a different respective optical superimposition noisy light signal that is an optical imposition of: A) a different respective noisy light response signal from a different respective scene location; and B) a respective reference optical signal whose temporal noise fluctuations are correlated to and temporally offset from the respective noisy light response signal. In these embodiments, each photodetector thus) generates a different respective temporally-fluctuating electrical signal that respectively describes the respective optical imposition noisy light signal.

Not wishing to be bound by any theory, it is noted that the cost-savings (i.e. in terms of computational power required) for embodiments where there are a plurality of photodetectors, for example, a large (e.g. at least 50 or at least 100 or at least 200 or at least 500 or at least 1,000 or at least 5,000) number of photodetectors of a two-dimensional array for image sensing may be substantial.

In some embodiments, a reference noise light signal is provided to each photodetector—for example, it is possible to simultaneously illuminate each photodetector of the array with the same ‘noisy light source signal’ that acts as a reference. In this case, each photodetector is simultaneously illuminated by: (i) a common source noisy light signal that is common to two or more of the photodetectors and (ii) respective target/scene-specific noisy light signal that is particular for a location in the scene for that photodetector (i.e. which will be represented as a pixel). Nevertheless, the use of a ‘common reference noisy light signal’ is not a limitation, and in other embodiments, it is possible to simultaneously illuminate photodetectors 120 of an array 170 by multiple noisy light signals without employing common references.

As with any embodiment, the ‘noisy light’ may be UV light and/or visible light and/or IR light (e.g. near IR light or thermal IR light or far IR light).

The source of the noisy light may be provided in any location—for example, mechanically coupled to the photodetectors via some sort of common device housing or in any other location (coupled or not).

A Discussion of Noisy Light with Reference to FIGS. 6-7

In various embodiments, a noisy light signal from a target object(s) or medium(s) is received into one or more optical receivers.

In different embodiments, one or more of (i.e. any combination of) 1) amplitude modulation, 2) phase modulation, 3) frequency modulation, 4) polarization modulation may be used to produce ‘noisy light.’

In particular, examples of possible amplitude modulation are 1) pulsed, 2) sinusoidal, 3) amplitude modulation such that the autocorrelation of the power signal has a Gaussian dependence on time, 4) amplitude modulation such that the autocorrelation of the power signal has a super-Gaussian dependence on time.

As noted earlier, in embodiments related to FIG. 6, the object(s) or medium are illuminated with noisy light provide by a noisy light source. In some embodiments related to FIG. 7, the target imbues the light with ‘noise’ characteristics.

Thus, in some embodiments, it is possible to provide apparatus that imbues noise characteristics upon at least one of the following: 1) the radiation source; or 2) the radiation in at least one of the optical paths between the illuminating radiation and at least one of the detectors.

In FIG. 6, electronic noise circuitry 90 is illustrated. In some embodiments, instead of (or in addition to) receiving a plurality of noisy light signals at one or more detectors, it is possible to electronically process an ‘input noise signal’ provided by noise circuitry 90—for example, to compute an autocorrelation function or one of more spectral functions involving a noisy light signal and an electronic noisy ‘driving signal’ from noisy circuitry 90.

As noted above, in order to produce ‘noisy’ light, it is possible to randomly or —pseudo-randomly modulate any combination of: light amplitude, light phase, light frequency and light polarization. Furthermore, in some embodiments, the modulation (e.g. amplitude modulation) may be 1) pulsed, 2) sinusoidal, 3) amplitude modulation such that the autocorrelation of the power signal has a Gaussian dependence on time, 4) amplitude modulation such that the autocorrelation of the power signal has a super-Gaussian dependence on time.

A Discussion of Computing a Phase Spectrum and of Computing Impulse Response with Reference to Step S109 of FIG. 1 and with Reference to FIG. 8

In addition to the above embodiments and applications, there will now be described embodiments for acquiring the optical impulse response of EM media. For example, a well-known technique known as pulsed laser radar for measuring the distance to the front of a remote object is to transmit a short pulse, on the order of nanoseconds, and measure the time it takes for the pulse to return to the detector. This technique is limited in depth resolution by the pulse length. This can be improved in principle by shortening the pulse width to have duration less than nanoseconds, but this comes at a significant cost in complexity and price. Moreover, this time-domain technique requires complex synchronization electronics. The invention disclosed herein overcomes these limitations by achieving high depth resolution without requiring short pulses.

In the embodiments described above, the true impulse response of the EM media (or “target”) to a pulse of EM power is not determined; rather, the temporal correlation function of the power signal returning from the media is determined. This is usually sufficient for media for which a small number of discrete scattering or reflection events take place.

If the target is more complex, e.g. consists of a large number of discrete scattering events, or continuously scatters the light in a diffuse fashion, then the PSD spectrum will accordingly be more complex as well. Examples of media of this type are: clouds, smoke, biological tissue, clothing, camouflage material, the atmosphere under certain conditions, optical fiber, bodies of water and other solids, liquids and gases under certain conditions. Under these conditions, a true impulse response is desired, since a correlation-type of response suffers from reduced temporal resolution and accuracy as opposed to the true impulse response, and so will not be able to temporally resolve the scattering behavior sufficiently. Even if the medium is not complex in terms of the number and type of scattering points, it would still be beneficial to know the true power impulse response, as opposed to the correlation-type of response.

An embodiment of the invention for determining the true power-impulse response of the EM medium is to carry out the following steps:

1. Determine PSD_{medium} as described in the first embodiment.

2. Calculate \sqrt{PSD_{medium}} which is the amplitude spectrum associated with the power transfer function spectrum for the medium.

3. Calculate the phase spectrum θ(f) associated with the said transfer function spectrum of the medium, through a phase-retrieval algorithm such the Kramers-Kronig technique, MEM technique or other techniques as described in, for example, co-pending International Patent Application WO 2009/098694 and U.S. Pat. No. 7,505,135 by the same applicant, the description of which, including publications referenced therein, is incorporated herein by reference; and

4. Calculate the true power impulse response of the medium by calculating the inverse Fourier transform of \sqrt{PSD_{medium}(f)} exp(iθ(f)).

This impulse response will reveal the relative distance to the various reflection or scattering points in the medium, as well as the overall scattering characteristics of the medium, such as the scattering coefficients, with a temporal resolution and accuracy significantly better than that of the power correlation signal technique.
In a similar fashion, the technique described in the steps above can be used for determining the distance to the target as well as the relative distances between scattering points in the target, by carrying out these 4 steps for the PSD_{out,sum} function as defined in eq. 1.

### Discussion of FIG. 9

FIG. 9 is a flow chart for monitoring mechanical or material properties of the fiber (or changes thereof) according to some embodiments.

In step S211, light is sent through an optical fiber. In one example, the noisy light is sent through the optical fiber. In another example, non-noisy light is sent through the optical fiber, but it is possible to employ a Brillouin scattering technique to imbue light with noise characteristics at any location.

In step S215, one or more detectors or illuminated by noisy light (e.g. by one or more noisy light signals—e.g. with or without light superimposition).

In step S219, it is possible to characterize mechanical and/or material properties of the fiber according to a temporally-fluctuating noisy electrical signal whose noise properties substantially correspond to the noise properties of one or more noisy light signals in step S215.

Mechanical or material properties in FIG. 9 which may be measured include but are not limited to: i) an optical fiber length; ii) an optical fiber attenuation; iii) locations of one or more splits or breaks or faults in the fiber; iv) stress or strain on the optical fiber; v) mated-connector losses and/or vi) break or cracks or other faults in the fiber.

In some embodiments, it is possible to measure the static or dynamic light distribution among modes of a multi-mode fiber.

FIG. 9B refers, in some embodiments, to an apparatus and method for measuring a mechanical and/or material property of an optical fiber in one non-limiting example.

In this figure numeral 9 represents an optical circulator, numeral 10 an optical fiber, and numeral 11 breaks, faults or other sources of power loss in the fiber. This embodiment of the invention can carry out all of the functions of a well-known device known as an optical time-domain reflectometer (OTDR), which measures points of optical loss along the fiber by sending pulsed light and measuring the pulse response reflected from the fiber.

In contrast to OTDR-related techniques, pulsed light is not required . In OTDR techniques, pulsed light may be used to shorten the “dead-zone”, i.e. the depth resolution, associated with the fiber measurement, which is proportional to the pulse length. In order to shorten the dead-zone in an OTDR device, the pulse length must be shortened. This adds complexity and cost to the system.

In some embodiments, the techniques for detecting mechanical and/or material properties of optical fibers do not require upon pulsed radiation—in these embodiments, it may be significantly easier to shorten the dead-zone, by measuring the spectrum over a wider spectral range. The ability to shorten the “dead zone” without requiring a light source with shorter pulses is a basic advantage of the disclosed technique over all other types of pulsed radar systems.

In yet another example, the ability to monitor the reflections from various points along an optical fiber is utilized to form the basis of a sensor of stress or strain on the fiber. For example, assume that the fiber has a series of N reflection points 1, 2, . . . , i, j, . . . N along its length that reflect a small portion of the radiation. These reflection points can be created, for example, with the use of connectors that physically bring the two fiber ends into a touching contact, and/or through the use of fiber Bragg gratings, which reflect a portion of the radiation whose spectral frequency and bandwidth match that of the grating's spectral response. If no pressure is on the fiber at any point, then the system of the invention will show pulsed reflections from each of the reflection points. However, if pressure is applied to a point along the fiber, e.g. between two adjacent reflectors i and j, then the system of the invention will detect this as a reduced reflection from the reflection points starting from point j. Those skilled in the art will understand that it is possible to design sensitive means for detecting pressure in this fashion, through various mechanical means of enhancing the optical loss from the fiber as a result of pressure. If fiber Bragg gratings are employed, then if pressure or strain is applied to one or more of the fiber gratings, then the spectral response of the grating changes, thereby changing the amount of reflection from that grating which can be monitored using a system of this invention.

A Discussion of Intrusion Detection

In some embodiments, it is possible to employ noisy light for ‘intrusion detection’—i.e. to detect mechanical motion of a person or animal or moving vehicle (e g manned or unmanned. This may be useful, for example, to determine in someone or something climbs a fence or moves across an area of land or comes into contact with an optical fiber or oil pipeline.

For example, it may be possible to determine when or if an optical path between a plurality of reflectors becomes blocked due to mechanical motion of an object (e.g. person or animal or moving vehicle) that previously was not blocking the path—see FIGS. 11-14.

In another example, it may be possible to measure force imposed (e.g. by someone or something climbing a fence) and/or a change in stress or strain—see, for example, FIGS. 15-16).

FIG. 10 is a flow chart of a routine for intrusion detection in some embodiments. Any combination of teaching(s) of FIG. 10 may be used, for example, to monitor, (e.g. in ‘real time’): (i) if a person climbs a fence and moves or otherwise stresses or strains a fiber optical cable attached to the fence and/or to measure a location where the fence is climbed; (ii) if someone sabotages or attempts to sabotage an fluid pipeline (e.g. a pipeline for transporting fuels such as oil or other petroleum products) where a fiber optic cable is mechanically coupled to the pipeline and runs along the length of the pipeline; and/or (iii) to detect sabotage or attempted sabotage of a fiber optical communications cable.

In step S311, a light signal from a source is sent to a detector via an optical path(s) (e.g. via an optical fiber, fiber free space). In the example of FIG. 13, there are two optical paths—a first path of light that reflects from the left reflector (having reflectivity a) and a second path of light that reflects from the right reflector (having reflectivity b), In the example of FIG. 15, the light travels to or through one or more spectrally selective reflector(s) (e.g. Bragg gratings). In this case, there may be multiple optical paths, each associated with a different spectrally-selective reflector.

In FIG. 16, an upper and lower fiber are associated with a delay line—the optical path may run through the fiber and the delay lines. In FIGS. 17A-17B, the optical paths may run via a multi-mode fiber that provides multiple optical paths, each one with different optical path.

In some embodiments, the routine of FIG. 10 detects the intrusion event according to changes in optical paths—i.e. at an earlier time the optical path(s) (or distribution of path(s) has a first value or set of characteristics, and at a later time the optical path(s) (or distribution of path(s) has a second value or set of characteristics different form the first value or set of characteristics. By using light to monitor optical path characteristics, it is possible to detect intrusion events.

In one example, the optical path is modified by changing its length—for example, an object (e.g. person, animal or moving vehicle) that previously to not block a line of site between left and right reflectors of FIG. 13 now blocks the line of site.

In another example, the optical path is modified by changing one or more refraction index properties—for example, by mechanically moving a brag gate of FIG. 15 or by moving a multi-mode fiber (e.g. to deform the fiber) which may change the mode distribution properties.

Thus, in step S319, noisy electrical signal(s) having temporal noise characteristics that match one or more noisy light signals are monitored.

In step S315, according to the monitored signal, it is possible to detector intrusion.

A Discussion of FIGS. 11-14

In some embodiments, it is possible in step S109 of FIG. 1 and/or in steps S1105 and/or S1109 of FIG. 18 to effect a so-called double-spectrum calculation. In some embodiments, it may thus first useful to compute a spectrum (e.g. of an electrical signal describing noisy light signal(s)) over a continuous range of frequencies.

In some embodiments, it is possible to detect a change in one or more optical paths by computing an amplitude and/or spectrum describing light power as a function of frequency for only a set of discrete frequencies—i.e. over only a discrete ‘spectrum ’

In some embodiments, this is useful for intrusion detection and may reduce the amount of electronics employed to detect changes in optical paths and/or intrusion events.

Thus, in some embodiments related to the ‘double spectrum technique,’ after the power signals are acquired for the illuminating radiation and returning radiation, all of the further steps in the analysis of these signals requires measuring the frequency spectrum of the signals over a full or continuous spectral range Δf. The value of the required spectral range is determined from the desired depth resolution δL≈c/2Δf where c is the speed of light. For example, a 1 GHz spectral range will give a resolution of approx. 15 cm.

In embodiments related to FIGS. 11-15, alternative techniques may be employed. For example, an important application is the situation whereby the medium consists of a known number of reflectors in known positions along the medium. A classic example of this would be an optical fiber which reflects a known portion of the radiation at each of N points along the fiber (FIG. 13 relates to the non-limiting case where N=2 but N can be any positive integer). The application calls for a sensor which can tell if there is a disruption in the light path somewhere along the fiber, say between reflector i and j. This sensor can be used for perimeter intrusion detection, for example, or for monitoring tampering of a fiber-optic communication link In these applications, where the information regarding the locations of the reflecting points is known a priori, it is not necessary to measure the frequency response over the full spectral range in order to determine the location of reflections (since their location is already known). Rather, it is sufficient to measure the power at certain frequencies (at least 2 frequency points) within the range Δf over a ‘discrete’ rather than continuous spectrum Therefore, instead of sending the output of the detector to an electronic spectrum analyzer to acquire the full spectrum (which can be expensive and complicated, especially for large Δf), it is sufficient to employ a plurality of filters and measure a power amplitude of an electrical signal describing a noisy light signal illuminating detector(s).

In the non-limiting example of FIG. 13, the output of the detector is electronically filtered with m narrow-band band-pass filters F1 to Fm within the range Δf, and by monitoring the values of the outputs of these filters, A1 to Am, it is possible to sense disruptions between reflecting points within the medium that is irradiated. In some example, these filters may be cheap and simple and obviate the need to electronically process a larger continuous spectrum

Although not illustrated in the figures, it is appreciated that the electronic filters may be augmented with and/or replaced by optical filters that allow only monochromatic light to illuminate any optical detector(s).

In FIG. 13, radiation Eᵢₙ(t) is directed towards a target consisting of two reflectors, one with reflection coefficient a and the other b (this is the simplest case, but can be expanded to a larger number of reflections). The reflected beams are combined to form the output beam Eₒᵤₜ(t). Therefore,

Eₒᵤₜ(t)=aEᵢₙ(t)+bEᵢₙ(t−T),

where T=2Ln/c is the relative time-lag for the arrival of the beam reflected from b with respect to that arriving from a due to a difference in propagation distance L to the two elements, n being the refractive index of the medium between the reflectors.
Since the radiation is varying randomly in time, the signal after the optical detector will be proportional to

sₒᵤₜ(t)=(a²sᵢₙ(t)+b²sᵢₙ(t−T)),

where sⱼ(t)≈|Eⱼ(t)|² is the intensity (or power) of radiation field j.
The Fourier transform of this signal is:

Sₒᵤₜ(f)=Sᵢₙ(f)(a²+b²e^{-2πfT}).

Therefore the power spectral density PSDₒᵤₜ is:

PSDₒᵤₜ≡|Sₒᵤₜ(f)²≈|Sᵢₙ(f)|²[a⁴+b⁴+2a²b² cos(2πfT)] (X)

Eq. (X) describes the distribution of the power among the frequency components of the spectrum For our example of two reflectors, it is sufficient to monitor the values of a and b in order to know if a disruption occurred between the two reflectors. This will happen, for example, if b is reduced while a stays constant.

Please note: it is not necessary to monitor the complete spectrum in order to determine these two values.

This can be seen by the following:

FIG. 14 depicts the PSD for the case of two reflectors as described above in eq. X. It varies sinusoidally with frequency, with an average value of a⁴+b⁴ and peak-to-peak swing of 4a²b².

For example, the values of a and b can be determined as follows: set the value of filter F1 such that it passes the power within a narrow band of frequencies around f₁, which satisfies 2πf₁T=π/2, or f₁=c/8 nL. The value of the output of this filter, A1, will be proportional to a⁴+b⁴. Set the value of filter F2 around f₂=c/4 nL, and its output value, A2, will be proportional to a⁴+b⁴−2a²b². From these two values, it is possible to continuously monitor the values of a and b.

A Discussion of FIG. 15

Some embodiments relate to spectrally-selective reflectors such as Bragg gratings.

For example, it is possible to employ wavelength multiplexing so that light from a noise source such as an erbium-doped fiber amplifier (EDFA) having a spectral bandwidth of approx. 30 nm in the telecommunication c-band is directed into an optical fiber. Along the fiber are Bragg gratings (BG) BG1 to BGn which selectively reflect light at wavelengths lambda1, lambda2 . . . lambda n. The returning light from each of these BG possesses statistically independent random noise. With the aid of a circulator, this light is directed into a demux which separates the n spectral components, and directs them to n separate detectors. In parallel, a portion of the noise source is shunted to the same demux. Therefore, detector i receives the light returning from BG i at wavelength i, plus light from the noise source itself at the same wavelength i. This is true for each of the channels i from 1 to n. Then the outputs of these detectors are processed in a fashion similar to the previous embodiment in order to monitor disruption in the light path along the fiber.

In FIG. 15, the noise source is a broadband signal that can be split into a plurality of noise signals—one from BG1, another from BG2, . . . and form BGn. BG1 acts as a reflector for a first sub-region of the noise spectrum from noise source, B2, acts as a reflector for a second sub-region of the noise spectrum, etc.

In different embodiments, the system of FIG. 15 may be used to measure a stress or strain (or change therof)—for example, which modifies the reflective properties of one or more spectrally selective reflectors.

In one example (this relates to FIG. 15 or any other figure related to mechanical properties or intrusion detection), it is possible to detect intrusion or any other mechanical stress or strain property including but not limited to optical fiber and another element mechanically coupled to an optical element (including but not limited to a selective reflector such as a Bragg grating).

### A Discussion of FIG. 16

FIG. 16 illustrates a system where in upper and lower fibers are mechanically coupled to each other either directly or via a third object—for example, the upper and lower fibers may be fastened to a fence and oriented substantially horizontally. At some point in time, both the upper and lower fibers are mechanically disturbed (or otherwise modulated) at a particular location Z=delta. In some embodiments, FIG. 16 relates to an intrusion detection technique for determining a value of delta to determine not just the existence of instruction, but its location.

The fibers may be single mode or multi-mode fibers.

In the system of FIG. 16, in the upper fiber, an optical mixture is generated between (i) the noisy light signal travelling from left to right in a first time reference frame; and (ii) the noisy light signal travelling from left to right in a first time reference frame offset by some time delay. Similarly, in the lower fiber, an optical mixture is generated between (i) the noisy light signal travelling from right to left in a first time reference frame; and (ii) the noisy light signal travelling from right to left in a first time reference frame offset by some time delay.

It is possible to monitor, over time, an autocorrelation of the light signal with a particular delay time. When the upper and lower fibers are simultaneously mechanically disturbed, temporal autocorrelations of the noisy optical signal in both the upper and lower fiber will change—however, they will not necessarily change at the same time. In the event that delta is much closer to Z=0, the temporal autocorrelation in the lower fiber will change at an earlier time than the temporal autocorrelation in the upper fiber. It is possible to measure a location z=delta in accordance with a positive or negative ‘time gap’ between (i) a first time when a temporal autocorrelation of a noisy light signal in the upper fiber changes; and ii) a second time when a temporal autocorrelation of a noisy light signal in the upper fiber changes.

FIG. 16 shows two fibers with noise-modulated light counter-propagating along them. At the output of the top fiber the light field is aE(t)+bE(t−T) due to the delay line which introduces a delay T. A similar situation occurs for the bottom fiber, where the constants c and d can in general differ from a and b. For the sake of simplicity, we will assume in what follows that c=a and d=b, however this is not a necessary requirement. The general idea is as follows: if at time t=0 the fiber is perturbed at z=δ and is sustained for a perturbing time τ, then at the output of the upper and lower fibers the perturbation will be detected as a transient change in the cross-correlation between E(t) and E(t−T) (the “perturbing signal”). This transient change will persist as long as the delayed wave E(t−T) differs from E(t). Eventually, depending on T and τ, the two waves will again be identical. In a preferred embodiment, T would be large enough so that the perturbing signal would be as long as τ. Therefore, each of the two fibers sensors below will detect this perturbation. The difference is in the time that it will take for the output of each of the fibers to show the perturbing signal. In the figure below, we can see that for the upper fiber the perturbation signal will be detected starting from a time (L−δ/v, and for the lower fiber the perturbing signal will reach the detector after time δ/v, where v is the speed of light in the fiber. From the difference between these two detection times, the location of the perturbation can be determined.

A Discussion of FIG. 17A-17B

In another embodiment, the sensing fiber is a multimode fiber 620, and for example step-index multimode fiber (and not graded index).

In this example, the output is noisy light—the input may or may not be noisy light. In FIGS. 17A-17B, the input is noisy light/. However, due to the fact that the light in a multimode fiber separates into a number of modes, each with a different propagation time in the fiber, the output consists of a light signal which is proportional to

$${\sum }_{1}^{N} {a}_{i} E ( t - {T}_{i} )$$

for the N modes. Therefore, the correlation of this signal will look something like the black curve in the plot below, where T₁ is the propagation time of the lowest order mode.
If the fiber is perturbed, then more light will be channeled into the higher-order modes, resulting in the red curve above. By comparing the two curves, one can determine that the fiber was perturbed.

Now in order to determine where the perturbation is located, one can employ the same counter-propagating idea described above with reference to FIG. 16. By measuring the time difference between the arrival of the two perturbation signals, one can determine where the perturbation is located.

### Additional Embodiments

The features in the present section may be combined with any embodiments disclosed herein, in any combination.

In some embodiments, it is possible to increase the optical frequency range in the following fashion: The medium is first irradiated with “noisy” EM radiation having a center frequency f₀ and bandwidth Δf. Then the signals are analyzed as described in the first embodiment. In the next step, the center frequency is changed to f₁=f₀+Δf while the noise characteristics are not changed so that the bandwidth Δf remains the same. Then the power signals are again analyzed as above. This process is repeated for N steps, where for each adjacent step fᵢ₊₁=fᵢ+Δf. In this fashion, the optical power response in a total optical bandwidth of N·Δf is measured with a spectral resolution determined by the electronic measuring means.

It will be obvious to those skilled in the art that there are numerous ways of carrying out the above embodiment. For example, the light source can be 1) a wavelength-tunable light source such as a laser that undergoes noise modulation through one of the various methods of producing noise that are known in the art or disclosed herein, or 2) an erbium doped fiber amplifier (EDFA) noise source that is split into N noise sources using, for example, a component known as a wavelength division demultiplexer, or 3) any light source characterized by a randomly varying amplitude and broad spectral bandwidth, and for which the center carrier frequency can be changed. In addition, it will be obvious that the N sequential measurement steps described in this embodiment can instead be carried out in parallel, through the use of a suitable optical means for separating the returning radiation from the target medium into N spectral windows, each of which are measured separately in an electronic measuring means that includes a detector and ESA or other electronic spectral measurement means. It will also be obvious that one or more of the spectral steps can be skipped, so that only a portion of the total optical spectrum width N·Δf will be measured.

Therefore, this invention has certain advantages over other spectral techniques that are applied to EM media. It allows for the acquisition of the spectral response of the medium to optical power signals with extremely high resolution, limited only by the electronic means, and can easily be on the order of 1 Hz or better. The spectral measurement is straightforward and relatively inexpensive. The types of spectral measurements include but are not limited to: spectral changes resulting from single or multiple specular reflections, single or multiple diffuse reflections, absorption, gain, and dispersion, where any of the above take place within or on the surface of the EM medium.

In different embodiments, it is possible to apply an optical delay on the optical path between the illuminating radiation and the detector of the illuminating radiation; by applying an optical delay on the optical path between the illuminating radiation and the detector of the radiation returning from the object or medium; or by applying an optical delay on the optical path between the illuminating radiation and the detector. Any of these methods can be carried out by splitting the illuminating beam into at least two paths whereby the at least two paths are of equal optical delay or of unequal optical delay.

In some of the above embodiments, acquisition of the power signal of the illuminating radiation can be carried out continuously throughout the process of measuring the returning radiation from the medium, or in certain situations it can be measured only once at the beginning of the measurement process, or in certain situations only at certain times during the measurement process. The latter options are possible if the average spectral characteristics and temporal characteristics of the illuminating radiation do not change significantly throughout the said measurement process, so that the signal waveform of the illuminating radiation can be stored electronically and then extracted from memory to be applied as explained in the various embodiments.

It is also to be understood that in some of the embodiments, instead of measuring the power signal of the actual source used as the irradiating radiation, it is possible to substitute in its place a different source having noise statistical characteristics and/or power spectrum that is substantially the same as of that of the actual source used for illuminating the object or medium. So, for example, the object or medium can be irradiated with an irradiation source from the same or different location as the measurement system, and another “local” source which is part of the measurement system is used as described in the various embodiments, to determine the optical power frequency response or impulse response of the object or medium.

It is also to be understood that in some of the embodiments, instead of measuring the power signal of the source used as the irradiating radiation, it is possible to substitute in its place a simulated power signal or spectrum that closely resembles or is identical to the actual irradiating source in terms of the noise statistics or spectrum.

In certain applications it will be advantageous to vary the optical delay of sᵢₙ(t) and/or of sₒᵤₜ(t) before one or both of the optical signals enter the detectors of FIG. 20, or FIG. 21 or other embodiments. This can be done by adding optical delay lines, which can consist of optical fiber of known lengths, or other optical elements such as mirrors, lenses and other components known in the art for causing an optical delay. The delay can be tunable or fixed. In addition, instead of adding one delay line for either or both of the signals, it is possible to split either or both of the optical signals into two or more delay lines or optical paths. This splitting can be done simultaneously into two or more delay lines, or by switching in tandem between two or more delay lines. The splitting mechanism can be a fiber coupler, beamsplitter, wavelength division demultiplexer, or any other component known in the art for splitting a light beam into two or more beams. The addition of optical delay can useful, for example, for increasing the depth range of the object or medium, for allowing measurements to be made on objects or media that are close to the measuring system, for improving the depth resolution of the measurement, as well as for achieving other improvements in the capabilities of the measuring system. In particular, by way of example, we point out that improving the depth resolution with this technique is of particular significance, since it enhances the resolution capabilities of the measurement beyond those allowed by the operating parameters of the measurement system, such as the bandwidth of the measurement Δf.

In non-limiting embodiments, the electronic means used to determine the PSD spectrum can comprise at least one of the following: an electronic spectrum analyzer (ESA), an electronic correlator circuit, a memory device, a computer, electronic circuitry to carry out any of the required algebraic functions and other signal processing tasks.

Another useful power signal having a useful PSD spectrum can be determined by performing a summation of the power signal of the illuminating radiation and of the power signal of the returning radiation. The summation can be performed by directing at least a portion of the illuminating radiation and at least a portion of the returning radiation onto the same detector, or by summing the power signal of the illuminating radiation and of the returning radiation with an electronic summing circuit or computer. Another useful power signal having a useful PSD spectrum can be determined by performing a subtraction of the power signal of the illuminating radiation and of the power signal of the returning radiation; alternately performing any algebraic calculation that is dependent upon the power signal of the illuminating radiation and the power signal of the returning radiation can be carried out to determine the resulting power signal having a PSD spectrum.

In some embodiments (for example, see step S109 of FIG. 1 or step S1105 of FIG. 18), a non-trivial mathematical function of multiple noisy electrical signals is processed—this function may be a ‘sum’ function or a different function or any other function.

For example, it is possible to analyze the difference signal:

sₒᵤₜ(t)=|ρ|²(sᵢₙ(t)−sᵢₙ(t−T))

or any other algebraic function of the two signals through electronic means. This may serve to enhance the characterization of the target by improving the depth resolution, signal-to-noise ratio, depth range or other aspects of the measurement technique.

It will be obvious to those skilled in the art that further variations on the above embodiments are possible which will aid in reducing the required electronic bandwidth to values below Δf. In addition, if the target consists of more than one reflection, especially if the number of reflections is known a priori, then suitable signal processing techniques can be utilized for reducing the required bandwidth and determining the delay times to the reflecting surfaces with high accuracy.

Some embodiments relate to a ‘double spectrum technique.’ However, any technique for analyzing a spectral distribution may be used. Thus, in some embodiments, it is possible to characterized optical power frequency response of the object or medium by doing any combination of the following:

a. using electronic means to determine the power spectral density (PSD) spectrum of the illuminating optical radiation from the measured power signal of the illuminating radiation;

b. using electronic means to determine the PSD spectrum of the returning optical radiation from the measured power signal of the returning radiation;

c. dividing the PSD spectrum of the returning radiation by the PSD spectrum of the illuminating radiation to determine the amplitude squared of the power transfer function spectrum.

In some of the above embodiments, acquisition of the power signal of the illuminating radiation can be carried out continuously throughout the process of measuring the returning radiation from the medium, or in certain situations it can be measured only once at the beginning of the measurement process, or in certain situations only at certain times during the measurement process. The latter options are possible if the average spectral characteristics and temporal characteristics of the illuminating radiation do not change significantly throughout the said measurement process, so that the signal waveform of the illuminating radiation can be stored electronically and then extracted from memory to be applied as explained in the various embodiments.

It is also to be understood that in some of the embodiments, instead of measuring the power signal of the actual source used as the irradiating radiation, it is possible to substitute in its place a different source having noise statistical characteristics and/or power spectrum that is substantially the same as of that of the actual source used for illuminating the object or medium. So, for example, the object or medium can be irradiated with an irradiation source from the same or different location as the measurement system, and another “local” source which is part of the measurement system is used as described in the various embodiments, to determine the optical power frequency response or impulse response of the object or medium.

It is also to be understood that in some of the embodiments, instead of measuring the power signal of the source used as the irradiating radiation, it is possible to substitute in its place a simulated power signal or spectrum that closely resembles or is identical to the actual irradiating source in terms of the noise statistics or spectrum.

In certain applications it will be advantageous to vary the optical delay of sᵢₙ(t) and/or of sₒᵤₜ(t) before one or both of the optical signals enter the detectors of FIG. 1, or FIG. 2 or other embodiments. This can be done by adding optical delay lines, which can consist of optical fiber of known lengths, or other optical elements such as mirrors, lenses and other components known in the art for causing an optical delay. The delay can be tunable or fixed. In addition, instead of adding one delay line for either or both of the signals, it is possible to split either or both of the optical signals into two or more delay lines or optical paths. This splitting can be done simultaneously into two or more delay lines, or by switching in tandem between two or more delay lines. The splitting mechanism can be a fiber coupler, beamsplitter, wavelength division demultiplexer, or any other component known in the art for splitting a light beam into two or more beams. The addition of optical delay can useful, for example, for increasing the depth range of the object or medium, for allowing measurements to be made on objects or media that are close to the measuring system, for improving the depth resolution of the measurement, as well as for achieving other improvements in the capabilities of the measuring system. In particular, by way of example, we point out that improving the depth resolution with this technique is of particular significance, since it enhances the resolution capabilities of the measurement beyond those allowed by the operating parameters of the measurement system, such as the bandwidth of the measurement Δf.

In some embodiments (e.g. related to FIG. 21), the spectrum is characterized, for example, by acquiring sᵢₙ(t) as the output of detector D₁ on which the “noisy” optical field is directed and then analyzing its spectrum PSDᵢₙ with the aid of an ESA or other electronic means, where, the detector and associated electronics having a spectral response that covers the range of at least Δf. In this embodiment, a portion of the radiation illuminates the EM medium to be analyzed, and the radiation returning from the EM medium after reflection, transmission, or some other deflection angle is monitored with a similar detector D₂, where both detectors are characterized by a spectral range that is preferably at least Δf, so that the signal exiting the detector has a power sₒᵤₜ(t) and PSDₒᵤₜ which can be determined using an ESA or other suitable electronic means. A comparison of PSDₒᵤₜ to PSDᵢₙ, such as the transfer function PSDₒᵤₜ/PSDᵢₙ, will give a characteristic spectral transfer function PSD_{medium} of the EM medium, with extremely high resolution.

Additional Comments

It is obvious that all of the figures herein are only schematic and are missing optical components for launching, collecting and detecting the EM radiation; specific means for measuring the source signal and spectrum, returning signal and spectrum and/or other components that are well-known to those skilled in the art that are necessary for carrying out the embodiments described herein as well as the directional EM beam control for scanning the target area. In addition, although the figures depict configurations whereby the exiting signal is reflected from the object, the invention is not limited to applications based on reflection configurations. It will be obvious to those skilled in the art that, in all embodiments of the invention, the illumination and detection geometry can involve reflection, transmission, or any other type of deflection of the radiation from the target

It is to be understood that in all of the embodiments described herein, it is possible to irradiate the object under test, be it a fiber or any other medium, with two or more EM sources characterized by the random statistics described earlier, in order to enhance the measuring capabilities of the system, These sources can illuminate the medium from the same direction or from different directions. For example, in the optical fiber-based embodiments, it is possible to illuminate the fiber from both ends in order to measure the frequency and/or impulse response as seen from both ends of the fiber. It is also to be understood that if two or more light sources are used, they can be of the same center frequency so that their spectrums' overlap, or substantially of different center frequencies so that their spectrums' partially overlap or do not overlap at all.

In some embodiments, it is possible to employ light that is 1) varying randomly only in phase and not in amplitude, or 2) varying randomly in phase as well as in amplitude (recall that the previous disclosures only discuss amplitude modulation). These phase changes are then measured using some type of interferometer before the detector (as opposed to the previous embodiments where the light enters the detector directly. The signal exiting the detector includes a term that is proportional to cos(øₛ(t)−øᵣ(t)), where øₛ(t) is the randomly varying phase signal that exits the medium and enters the interferometer, and øᵣ(t) is the randomly varying reference phase signal that is formed in the interferometer, and is usually a delayed form of øₛ(t). This reference phase signal can be formed in an interferometer that is after the medium, or it can be formed in an interferometer where the interferometer itself is part of the medium (such as two fibers running along a fence, one fiber is the signal path and the other is the reference path, or in another embodiment only one fiber runs along the fence and the interferometer is formed after the signal exits the signal-forming fiber, or another embodiment where the signal and reference paths are two different modes of a multimode fiber—other embodiments are of course possible).

Another difference between this disclosure and the previous ones is that the processing

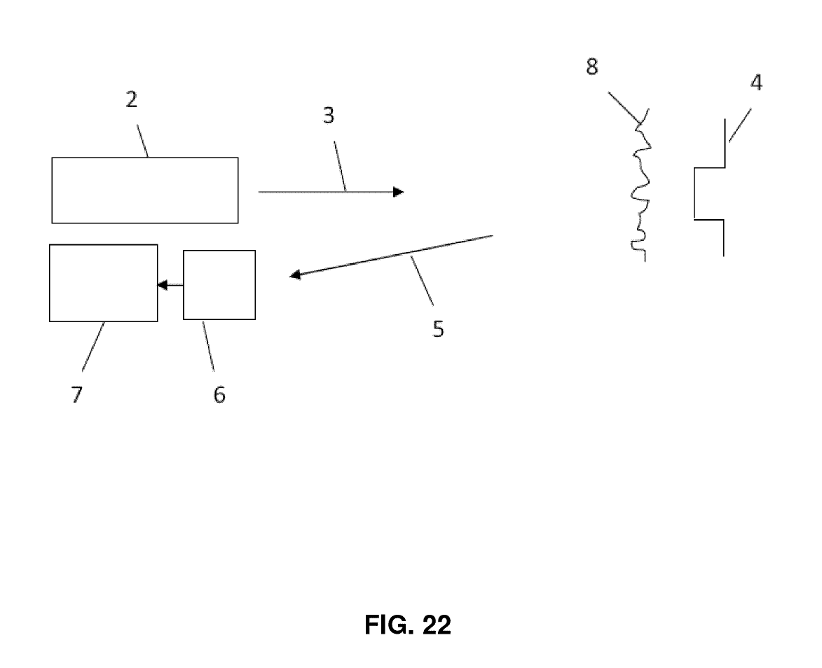

A Discussion of FIG. 22

In another embodiment, it is possible to image objects that are behind a medium, such as trees, other foliage, camouflage material or cloud cover, that partially obscures the object. FIG. 4 schematically shows the system. In this application, a preferred embodiment would be to determine the power impulse response of the target as described above, thereby revealing the distance to the sources of the multiple reflections.

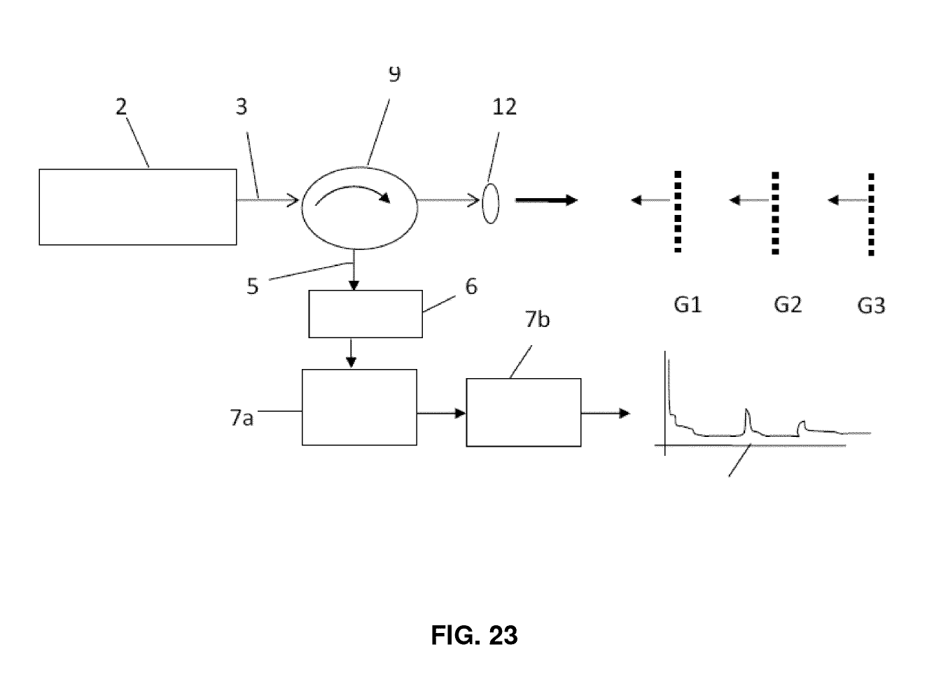

### Experiments—see FIG. 23

An experimental setup is shown schematically in FIG. 23. An EDFA was used as the “noisy” light source 2. The output 2 from the EDFA passed through optical circulator 9 and was collimated and illuminated a target which consisted of one, two or three glass plates G1-G3, separated by approximately 25 cm. The returning light 5 was detected with a 1GHz bandwidth detector and then sent to an ESA 7a for determining the PSD of the signal returning from the target. Finally, the data was processed in computer 7b and the impulse response displayed on a display device 13.

In the first experiment, the reference PSD spectrum of the source was established with the light returning only from plate G1. The spectrum after averaging is shown in FIG. 7.

After measuring the reference, spectrum plate G2 was added at a distance of 25 cm. The resulting PSD spectrum and impulse response are shown in FIG. 8A and FIG. 8B respectively.

In the next experiment G2 was removed and G3 was inserted at a distance of 50 cm from G1. The resulting spectrum and impulse response are shown in FIG. 9A and FIG. 9B respectively.

In the final experiment of this series G2 was reinserted so that all the plates were present. The resulting spectrum and impulse response are shown in FIG. 10A and FIG. 10B respectively.
In another experiment the glass plates were replaced with optical fiber of various lengths. The FIG. 11A and FIG. 11B show the impulse response for a length of 2 meters and for a length of 18 meters respectively.
All of these figures show impulse responses that are in perfect agreement with the expected time-of-flight from the various reflection points along the target.

It is further noted that any of the embodiments described above may further include receiving, sending or storing instructions and/or data that implement the operations described above in conjunction with the figures upon a computer readable medium. Generally speaking, a computer readable medium may include storage media or memory media such as magnetic or flash or optical media, e.g. disk or CD-ROM, volatile or non-volatile media such as RAM, ROM, etc. as well as transmission media or signals such as electrical, electromagnetic or digital signals conveyed via a communication medium such as network and/or wireless links

Having thus described the foregoing exemplary embodiments it will be apparent to those skilled in the art that various equivalents, alterations, modifications, and improvements thereof are possible without departing from the scope and spirit of the claims as hereafter recited. In particular, different embodiments may include combinations of features other than those described herein. Accordingly, the claims are not limited to the foregoing discussion.

1) A method of optically probing an object(s) and/or a medium and/or an optical path including the object(s) or medium, the method comprising:
a) illuminating the object(s) or the medium to induce, from the object(s) or medium, one or more noisy light response signals that are randomly or pseudo-randomly modulated;
b) receiving into an optical detector an optical superimposition of (i) a source light signal used in step (a) to carry out the illuminating and (ii) one or more of the induced noisy light response signals, thereby illuminating the optical detector so as to generate a combination electrical signal describing the optically superimposed plurality of received noisy light response signals;
c) determining or characterizing or detecting from the combination electrical signal, at least one of:
i) a relationship between power and frequency of the combination electrical signal or a derivative thereof over a discrete or continuous spectrum;
ii) a temporal autocorrelation function of the combination electrical signal;
iii) a distance parameter(s) involving one or more the objects;
iv) a mechanical stress or strain;
v) a change in a light propagation time of at least one optical path;
vi) a difference in light propagation times of multiple optical paths or a temporal change thereof;
vii) mechanical motion of an object; and
viii) a material or mechanical property of an optical fiber, at least a portion of which is included in the optical path of step (a).

2. (canceled)

3) The method of claim 1 wherein step (c) or a portion thereof is contingent upon the sub-signals of the combination electrical signal sharing substantially the same noise-driven temporal fluctuations.

4-6. (canceled)

7) The method of claim 1 wherein the mechanical stress or strain is determined or characterized or detected

8-19. (canceled)

20) The method of claim 1 wherein the method includes analyzing noise patterns of the combination electrical signal or of a derivative thereof.

21) The method of claim 1 wherein step (c) or a portion thereof is carried out in accordance with the results of the analysis of the noise patterns.

22) The method of claim 1 wherein the source signal used in step (a) to carry out the illuminating is a noisy source signal.

23) The method of claim 1 wherein the source signal used in step (a) to carry out the illuminating is not a noisy source signal.

24-26. (canceled)

27) The method of claim 1 wherein a bandwidth of the optical detector exceeds a noise bandwidth of one or more of noisy light signals of the optical superimposition received therein by at least a factor of 1,000.

28-30. (canceled)

31) The method of claim 1 wherein a noise bandwidth of one or more of noisy light signals of the optical superimposition exceeds a bandwidth of the optical detector by at least a factor of 1,000.

32-34. (canceled)

35) The method of claim 1 wherein a noise bandwidth of one or more of noisy light signals of the optical superimposition and/or a bandwidth of the optical detector is less than 100 MHz.

36) The method of claim 1 wherein the source signal used in step (a) to carry out the illuminating is a noisy source signal having a noise bandwidth selected in accordance with a desired depth resolution.

37-41. (canceled)

42) A 3D digital camera device for acquiring a digital image of a scene comprising:
a) a noisy light source configured to generate noisy light that is randomly or pseudo-randomly modulated, thereby illuminating a plurality of different scene locations within the scene to induce noisy light response signals from the different scene locations within the scene;
b) an image sensor including a substantially-planar two-dimensional array of photodetector;
c) optical components configured to focus or re-direct noisy light received from the scene onto or to the image sensors, the optical component(s) and the image sensor being configured so that each photodetector of the two-dimensional array:
i) is respectively illuminated by a different respective optical superimposition noisy light signal that is an optical imposition of:
A) a different respective noisy light response signal from a different respective scene location; and
B) a respective reference optical signal whose temporal noise fluctuations are correlated to and temporally offset from the respective noisy light response signal; and
ii) generates a different respective temporally-fluctuating electrical signal that respectively describes the respective optical imposition noisy light signal;
d) electrical circuitry configured to compute from temporal power spectral density data or temporal autocorrelation data of the temporally-fluctuating electrical signals generated by the photodetectors, a three-dimensional digital image including a plurality of pixels corresponding to the locations in the scene, each visually pixel representing depth data and grayscale or color data at respective location.

43-50. (canceled)

51. A method of optically probing an object(s) and/or a medium and/or an optical path including the object(s) or medium, the method comprising:
a) illuminating the object(s) or the medium to induce, from the object(s) or medium, a plurality of noisy light response signals that are randomly or pseudo-randomly modulated, each induced noisy light response signal of the optical superimposition being associated with a different respective target location of the object(s) or medium and with a different respective target-location-including optical path;
b) receiving into an optical detector an optical superimposition of the plurality of the noisy light response signals so as to illuminate the optical detector and to generate a combination electrical signal describing the optically superimposed plurality of received noisy light response signals;
c) determining or characterizing or detecting from the combination electrical signal, at least one of:
i) a relationship between power and frequency of the combination electrical signal or a derivative thereof over a discrete or continuous spectrum;
ii) a temporal autocorrelation function of the combination electrical signal;
iii) a distance parameter(s) involving one or more the objects;
iv) a mechanical stress or strain;
v) a change in a light propagation time of at least one optical path;
vi) a difference in light propagation times of multiple optical paths or a temporal change thereof;
vii) mechanical motion of an object; and
viii) a material or mechanical property of an optical fiber, at least a portion of which is included in the optical path of step (a).

52) The method of claim 51 wherein step (c) or a portion thereof is contingent upon the sub-signals of the combination electrical signal sharing substantially the same noise-driven temporal fluctuations.

53) The method of claim 51 wherein the mechanical stress or strain is determined or characterized or detected

54) The method of claim 51 wherein the method includes analyzing noise patterns of the combination electrical signal or of a derivative thereof.

55) The method of claim 51 wherein step (c) or a portion thereof is carried out in accordance with the results of the analysis of the noise patterns.

56) The method of claim 51 wherein a bandwidth of the optical detector exceeds a noise bandwidth of one or more of noisy light signals of the optical superimposition received therein by at least a factor of 1,000.

57) The method of claim 51 wherein a noise bandwidth of one or more of noisy light signals of the optical superimposition exceeds a bandwidth of the optical detector by at least a factor of 1,000.

58) The method of claim 51 wherein a noise bandwidth of one or more of noisy light signals of the optical superimposition and/or a bandwidth of the optical detector is less than 100 MHz.

59) The method of claim 51 wherein the source signal used in step (a) to carry out the illuminating is a noisy source signal having a noise bandwidth selected in accordance with a desired depth resolution.
